(19) United States
(12) Patent Application Publication
(10) Pub. No.: US 2020/0033849 A1
(43) Pub. Date: Jan. 30, 2020

(54) METHODS AND ARRANGEMENTS TO SIGNAL FOR AERIAL VEHICLES

(71) Applicant: INTEL IP CORPORATION, SANTA CLARA, CA (US)

(72) Inventors: Lai Kuen Candy YIU, Portland, OR (US); Youn Hyoung HEO, Seoul (KR); Feng XUE, Redwood City, CA (US); Rakesh KALATHIL, San Jose, CA (US)

(73) Assignee: INTEL IP CORPORATION, SANTA CLARA, CA (US)

(21) Appl. No.: 16/500,889

(22) PCT Filed: May 4, 2018
(86) PCT No.: PCT/US2018/031135

§ 371 Date: Oct. 4, 2019

Related U.S. Application Data
(60) Provisional application No. 62/502,389, filed on May 5, 2017.

(51) Int. Cl. G05D 1/00; B64C 39/02; G05D 1/06; H04W 24/10; H04W 76/27; H04W 8/24; H04J 11/00; H04B 7/185

(52) U.S. Cl. CPC G05D 1/0022; B64C 39/024; G05D 1/0607; H04B 7/18506; H04W 76/27; H04W 8/245; H04J 11/0036; H04W 24/10

(57) ABSTRACT

Logic may signal capability and interference control between a base station and a user equipment in an aerial vehicle. Logic may receive capabilities information from a user device to indicate that the user device is part of an aerial vehicle (AV-UE). Logic may transmit a measurement configuration to establish a trigger event based on a height or other measurement to instruct the AV-UE to transmit, in response to detection of the trigger event, a measurement report to the base station comprising interference information for downlink communications. And logic may transmit capabilities information from a user device to indicate that the user device is part of an aerial vehicle (AV-UE) and receive a measurement configuration to establish a trigger event based on a height or other measurement to instruct the AV-UE to transmit, in response to detection of the trigger event, a measurement report to the base station.

### CROSS REFERENCE TO RELATED APPLICATIONS

This application claims priority under 35 USC § 119 from U.S. Provisional Application No. 62/502,389, entitled “AERIAL VEHICLE (DRONE) INTERFERENCE CONTROL SIGNALING AND CAPABILITY”, filed on May 5, 2017, the subject matter of which is incorporated herein by reference.

### TECHNICAL FIELD

Embodiments herein relate to wireless communications, and more particularly, to signaling capability and interference control for aerial vehicles such as drones.

### BACKGROUND

There have been increasing interests in covering the aerial vehicles such as drones with cellular networks. The use cases of commercial drones are growing very rapidly and include package delivery, search-and-rescue, monitoring of critical infrastructure, wildlife conservation, flying cameras, and surveillance. All these use cases could see rapid growth and more will emerge in coming years.

### BRIEF DESCRIPTION OF THE DRAWINGS

FIG. 1 depicts an embodiment of a communication network to support communications with aerial vehicles;

FIG. 2 depicts an embodiment of a simplified block diagram of a base station and an aerial vehicle user equipment (AV-UE);

FIG. 3 depicts an embodiment of an AV-UE;

FIGS. 4A-4K depict embodiments of communications between an aerial vehicle user equipment and a base station;

FIGS. 5A-B depict embodiments of flowcharts to signal capability and interference control for a base station and an AV-UE;

FIG. 6 depicts an embodiment of protocol entities that may be implemented in wireless communication devices;

FIG. 7 depicts an embodiment of the formats of physical layer (PHY) data units (PDUs);

FIG. 8A depicts an embodiment of communication circuitry;

FIG. 8B depicts an embodiment of radio frequency circuitry;

FIG. 9 depicts an embodiment of a storage medium;

FIG. 10 depicts an embodiment of an architecture of a system of a network;

FIG. 11 depicts an embodiment of components of a device of an AV-UE and/or a base station;

FIG. 12 depicts an embodiment of interfaces of baseband circuitry; and

FIG. 13 depicts an embodiment of a block diagram illustrating components.

### DETAILED DESCRIPTION OF EMBODIMENTS

The following is a detailed description of embodiments depicted in the drawings. The detailed description covers all modifications, equivalents, and alternatives falling within the appended claims.

Many of these emerging use cases could benefit from connecting drones to the cellular network as a user equipment (UE). A wireless technology such as 3rd Generation Partnership Project (3GPP), 3GPP Long Term Evolution (LTE) is well positioned to serve aerial vehicles such as drones. In fact, there have been increasing field trials involving using LTE networks to provide connectivity to drones. It is predicted that a rapid and vast growth in the drone industry will bring new promising business opportunity for LTE operators.

However, enhancements may be identified to better prepare the LTE networks for the data traffic growth from aerial vehicles in the coming years. For example, an air-borne UE may experience radio propagation characteristics that are likely to be different from those experienced by a UE on the ground. As long as an aerial vehicle is flying at low altitude, relative to the BS antenna height, it behaves like a conventional UE. However, once an aerial vehicle is flying well above the BS antenna height, the uplink (UL) signal from the aerial vehicle becomes more visible to multiple cells due to line-of-sight propagation conditions. The UL signal from an aerial vehicle increases interference in the neighbor cells. The increased interference gives a negative impact to the UE on the ground, e.g. smartphone, Internet of things (IoT) device, etc. This could lead to a network limiting the admission of aerial vehicles so that the perceived throughput performance of the conventional UEs is not deteriorated.

Furthermore, there are regulatory aspects specifically for drones. Two types of “drone UE” are observed in the field. One is a drone equipped with a cellular module certified for aerial usage. On the other hand, there might be a drone carrying a cellular communication module such as a smart phone that is only certified for terrestrial operation. Such usage may not be permitted from a regulatory standpoint in certain regions. In that sense, the UL signal from such a UE can be regarded as jamming.

Embodiments may define signaling for capabilities of aerial vehicle user equipment (AV-UE) for Radio Access Networks (RANs) such as RAN1, RAN2, RAN3, and RAN4 as well as for base stations such as the evolved Node B (eNB) and the Next Generation Node B (gNB). RAN may be shorthand for E-UTRAN (Evolved Universal Terrestrial Radio Access Network) and the numbers 1, 2, 3, and 4 may represent the release numbers for the 3GPP E-UTRAN specifications.

Embodiments of base stations and AV-UEs may be capable of signaling capabilities to identify a base station as a base station specialized for AV-UEs and to identify the AV-UE as part of an aerial vehicle; decoding/encoding downlink data comprising the capabilities information of the AV-UE, respectively; encoding/decoding uplink data comprising the capabilities information of the base station, respectively; to support a new measurement event to trigger a measurement report based on height and number of cell exceeds a threshold; to receive/send a measurement report including location information, flying path, and the like; and/or to identify aerial vehicle functions for interference control. For example, an embodiment of an AV-UE may comprise a communications module with a subscriber identity module (SIM) designed for aerial vehicles only or may comprise a communications module that is designed for terrestrial use and is currently acting as an AV-UE. Furthermore, a base station of a cell may be designed for terrestrial UE or may be designed, or specifically equipped for communications with AV-UEs.

In several embodiments, the base station may include one or more functional modules with new capabilities for mitigating downlink (DL) and/or uplink (UL) interference related to communications with the AV-UE. For example, baseband processing circuitry of the base station may configure a measurement configuration for AV-UE such as interference measurement, height threshold, a height range, a velocity threshold, a velocity threshold in conjunction with a height threshold, scaling factors for interference measurements, scaling factors for time-to-trigger, scaling factors for Layer-3 (L3) filtering, and the like. This measurement configuration can be aerial vehicle specific or generic. This measurement can be configured periodically or event triggered for the AV-UE to send measurement reporting.

Similarly, the AV-UE may comprise new measurement triggers to trigger preparation and transmission of a measurement report such as an aggregated INTERFERENCE measurement from more than one or all cells that exceeds a threshold, a height measurement that exceeds a height threshold, a height measurement that places the AV-UE within a particular range of heights, a velocity measurement at a particular height measurement or range of heights, and/or the like.

Many embodiments of base stations may configure a UL measurement and/or the AV-UE may detect a trigger for a UL measurement. For instance, baseband processing circuitry of the base station may configure the UL measurement such that the AV-UE may transmit a reference signal such as a sounding reference signals (SRS) for channel sounding. Configuring the UL measurement may enable the base station and/or other base stations to measure UL interference at any time, to measure UL interference upon request by the AV-UE to enable an AV-UE feature, and/or to measure UL interference in response to detection by the base station of AV-UE behavior such as flying.

In several embodiments, the base station may also mitigate interference via interference nulling. For instance, baseband processing circuitry of the base station may configure interference nulling and/or the AV-UE may detect an interference nulling trigger to begin beamforming at some angle or to a first set of one or more cells to mitigate interference at a second set of one or more cells based on interference detected at the second set of one or more cells that exceeds a threshold and/or a measurement by the AV-UE that exceeds a threshold. Note that for each discussion herein that states that a measurement exceeds a threshold, other embodiments may perform the same action if the measurement reaches a threshold, falls within a range of a threshold, or falls below a threshold depending on the nature of the threshold calculation and the measurement.

Some embodiments signal via a radio resource control (RRC) layer signaling to a dedicated AV-UE and/or via a system information block (SIB) broadcast to all AV-UE, a group of AV-UE, or an individual AV-UE. For instance, once the AV-UE is in the RRC layer connected state, the AV-UE may monitor frequency layers such as E-UTRA intra frequency, E-UTRA inter frequency, Inter-RAT UTRA Frequency Division Duplex (FDD), UTRA Time Division Duplex (TDD), and Global System for Mobile communication (GSM) measurements that are applicable to the AV-UE. Many embodiments have configured measurement types such as Primary Common Control Physical Channel (P-CCPCH), Received Signal Code Power (RSCP), Common Pilot Channel (CPICH) measurements, High Rate Packet Data (HRPD), Code Division Multiple Access (CDMA), Global Navigational Satellite System (GSM) carrier Received Signal Strength Indicator (RSSI), Reference Signal Received Power (RSRP), Reference Signal Received Quality (RSRQ), Reference Signal Received Power (RSTD), Reference Signal-Signal to Noise and Interference Ratio (RS-SINR), New Radio Synchronization Signal-Reference Signal Received Power (NR SS-RSRP), New Radio Synchronization Signal-Reference Signal Received Quality (NR SS-RSRQ), and New Radio Synchronization Signal-Signal to Noise and Interference Ratio (NR SS-SINR).

The RRC layer connected state is an initial connection between a AV-UE and a base station in which the RRC layer of the base station connects with the RRC layer of the AV-UE. In several embodiments, baseband processing circuitry of the base station may configure one or more scaling factors and/or baseband processing circuitry of the AV-UE may comprise one or more scaling factors related for measurement report configuration such as a scaling factor for a time-to-trigger and for L3 filtering related to handover procedures.

For RANs, the base station may execute code and protocols for E-UTRA (Evolved Universal Terrestrial Radio Access). The E-UTRA is an air interface for base stations and interaction with other devices in the E-UTRAN such as AV-UE. The E-UTRA may include the radio resource management (RRM) in a RRC layer and the RRM may determine a measurement report configuration for an AV-UE. For instance, baseband processing circuitry of the base station may generate the measurement configuration to send to a physical layer of the base station, to transmit the measurement configuration applicable for an AV-UE in RRC_CONNECTED by means of dedicated signaling, using, e.g., the RRCConnectionReconfiguration or RRCConnectionResume message. In many embodiments, baseband processing circuitry of the base station may send via an interface and a physical layer may transmit, to the AV-UE, a measurement configuration via one or more MAC layer Service Data Units (MSDUs) encapsulated in one or more PHY radio frames. In several embodiments, the RRM may communicate with AV-UE to receive signaling from the AV-UE that indicates the measurement capabilities of the AV-UE.

The PCell is the cell operating on the primary frequency in which the UE either performs the initial connection establishment procedure or initiates the connection re-establishment procedure to connect with the RRC of a base station, or the cell indicated as the primary cell in the handover procedure between base stations or Radio Access Technologies (RATs). The SCell is a cell operating on a secondary frequency, which may be configured once an RRC connection is established and which may be used to provide additional radio resources and/or for load balancing between base stations. For an AV-UE configured with dual connectivity (DC), the subset of serving cells that are not part of the Master Cell Group (MCG), and that comprise the PSCell and zero or more other secondary cells is referred to as the Secondary Cell Group (SCG). Furthermore, a PSCell is the SCG cell in which the AV-UE is instructed to perform random access or initial Physical Uplink Shared Channel (PUSCH) transmission if random access procedure is skipped when performing an SCG change procedure.

Cells generally refer to the geographic location serviced by a base station such as an eNB and a gNB. Each cell is associated with an ID to uniquely identify cells, at least within the local area, and cells have various sizes that may depend of the radio coverage of the base station that services the cell.

Various embodiments may be designed to address different technical problems associated aerial vehicle user equipment (AV-UE) communications such as interference related to a height of the AV-UE, interference related to a height range of the AV-UE, interference related to a velocity of the AV-UE at a height or within a height range, interference related to flight at heights above a base station antenna, interference related to line-of-sight conditions for multiple base stations and terrestrial UEs such as smart phones and Internet of Things devices, perceived throughput performance related to interference from AV-UEs, regulatory aspects of communications equipment that is only certified for terrestrial operation, determination of a preferred base station for a handover, determination of an appropriate time to trigger (TTT) to mitigate a wasteful ping-pong handover effect and avoid undesirable radio link failure (RLF) due to delayed handover, determination of appropriate L3 filtering to avoid an unwanted handover related to a low or high measurement, and/or the like.

Different technical problems such as those discussed above may be addressed by one or more different embodiments. Embodiments may address one or more of these problems associated with aerial vehicle user equipment (AV-UE) communications. For instance, some embodiments that address problems associated with aerial vehicle user equipment (AV-UE) communications may do so by one or more different technical means, such as, encoding, by the baseband processing circuitry, capabilities information of uplink/downlink data to a user device/base station, the capabilities information for the AV-UE to indicate that the user device is part of an aerial vehicle and the capabilities information for the base station to indicate that the base station includes features to support aerial vehicles; decoding, by the baseband processing circuitry, capabilities information of uplink/downlink data from a user device/base station, the capabilities information for the AV-UE to indicate that the user device is part of an aerial vehicle and the capabilities information for the base station to indicate that the base station includes features to support aerial vehicles; sending/receiving, by the baseband processing circuitry to/from a physical layer via an interface, a measurement configuration, the measurement configuration to establish a trigger event based on a height measurement, the measurement configuration to instruct the AV-UE to transmit, in response to detection of the trigger event, a measurement report to a base station comprising interference information for downlink communications between the base station and the AV-UE; sending/receiving, by the baseband processing circuitry to/from a physical layer via an interface capability information to indicate that the base station includes specialized aerial vehicle features to support communications with the AV-UE; sending/receiving, by the baseband processing circuitry to/from a physical layer via an interface capability information to indicate that one or more of the specialized aerial vehicle features are enabled; sending/receiving, by the baseband processing circuitry to/from a physical layer via an interface capability information to indicate parameters for one or more specialized aerial vehicle features that are valid and that the AV-UE will use if the base station enables the one or more specialized aerial vehicle features; sending/receiving, by the baseband processing circuitry to/from a physical layer via an interface capability information to indicate one or more other base stations that include specialized features to support communications with the AV-UE; sending/receiving, by the baseband processing circuitry to/from a physical layer via an interface, a signal to enable or disable communications between the base station and the AV-UE via a radio resource control (RRC) layer message; sending/receiving, by the baseband processing circuitry to/from a physical layer via an interface, a signal to enable or disable communications between the base station and the AV-UE via a radio resource control (RRC) layer message or a system information block, wherein the system information block is transmitted to the AV-UE, to a group of AV-UEs, or to all AV-UEs; sending/receiving, by the baseband processing circuitry to/from a physical layer via an interface, a measurement configuration specific for aerial vehicle application comprising both periodic and event trigger measurement events; sending/receiving, by the baseband processing circuitry to/from a physical layer via an interface, a measurement configuration specific for aerial vehicle application to trigger an aerial vehicle function other than generation of a measurement report; wherein the measurement configuration comprises one or more exit criteria for the aerial vehicle function; wherein the aerial vehicle function comprises an interference avoidance function; wherein an interference avoidance function comprises an interference nulling function; wherein an interference avoidance function comprises an interference mitigation function; wherein the AV-UE comprises a user equipment with a subscriber identity module (SIM) to enable an aerial vehicle features, wherein the SIM is a physical SIM or a Soft SIM; wherein the measurement configuration comprises a measurement of height, velocity, and interference from one or more cells and a measurement of a number of detected cells, the measurement configuration to include a threshold for the number of detected cells as a second trigger event, to instruct the AV-UE to transmit, in response to detection of the second trigger event, a measurement report to the base station; wherein the measurement configuration comprises configuration of an uplink measurement for the AV-UE; sending/receiving, by the baseband processing circuitry to/from a physical layer via an interface, a map of a high-density area for communications to instruct the AV-UE to enable an aerial vehicle function; sending/receiving, by the baseband processing circuitry to/from a physical layer via an interface, the map of the high-density area for communications to instruct, with a map based trigger event, the AV-UE to reduce power for transmissions from the AV-UE in response to entering an indicator area identified by the map; sending/receiving, by the baseband processing circuitry to/from a physical layer via an interface, a communication to enable a specialized aerial vehicle feature, the specialized aerial vehicle feature to comprise interference nulling; sending/receiving, by the baseband processing circuitry to/from a physical layer via an interface, interference control signaling via radio resource control layer (RRC) messages; sending/receiving, by the baseband processing circuitry to/from a physical layer via an interface, interference control signaling via Physical Downlink Control Channel (PDCCH) signaling; and/or the like.

Several embodiments comprise systems such as base stations, access points, and/or user equipment (UE) such as mobile devices (laptop, cellular phone, smart phone, tablet, and the like). In various embodiments, these devices relate to specific applications such as package delivery, search and rescue, monitoring of critical infrastructure, wildlife conservation, flying cameras, surveillance, healthcare, home, commercial office and retail, security, and industrial automation and monitoring applications, as well as other aerial vehicle applications (airplanes, drones, and the like), and the like.

The techniques disclosed herein may involve transmission of data over one or more wireless connections using one or more wireless mobile broadband technologies. For example, various embodiments may involve transmissions over one or more wireless connections according to one or more 3rd Generation Partnership Project (3GPP), 3GPP Long Term Evolution (LTE), 3GPP LTE-Advanced (LTE-A), 4G LTE, and/or 5G New Radio (NR), technologies and/or standards, including their revisions, progeny and variants. Various embodiments may additionally or alternatively involve transmissions according to one or more Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS) technologies and/or standards, including their revisions, progeny and variants.

Examples of wireless mobile broadband technologies and/or standards may also include, without limitation, any of the Institute of Electrical and Electronics Engineers (IEEE) 802.16 wireless broadband standards such as IEEE 802.16m and/or 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their revisions, progeny and variants.

Some embodiments may additionally or alternatively involve wireless communications according to other wireless communications technologies and/or standards. Examples of other wireless communications technologies and/or standards that may be used in various embodiments may include, without limitation, other IEEE wireless communication standards such as the IEEE 802.11, IEEE 802.11a, IEEE 802.11b, IEEE 802.11g, IEEE 802.11n, IEEE 802.11u, IEEE 802.11ac, IEEE 802.11ad, IEEE 802.11ae, IEEE 802.11af, IEEE 802.11ah, IEEE 802.11ai, IEEE 802.11-2016 and/or standards, High-Efficiency Wi-Fi standards developed by the IEEE 802.11 High Efficiency WLAN (HEW) Study Group, Wi-Fi Alliance (WFA) wireless communication standards such as Wi-Fi, Wi-Fi Direct, Wi-Fi Direct Services, Wireless Gigabit (WiGig), WiGig Display Extension (WDE), WiGig Bus Extension (WBE), WiGig Serial Extension (WSE) standards and/or standards developed by the WFA Neighbor Awareness Networking (NAN) Task Group, machine-type communications (MTC) standards such as those embodied in 3GPP Technical Report (TR) 23.887, 3GPP Technical Specification (TS) 22.368, 3GPP TS 23.682, 3GPP TS 36.133, 3GPP TS 36.306, 3GPP TS 36.321, 3GPP TS.331, 3GPP TS 38.133, 3GPP TS 38.306, 3GPP TS 38.321, and/or 3GPP TS 38.331, and/or near-field communication (NFC) standards such as standards developed by the NFC Forum, including any revisions, progeny, and/or variants of any of the above. The embodiments are not limited to these examples.

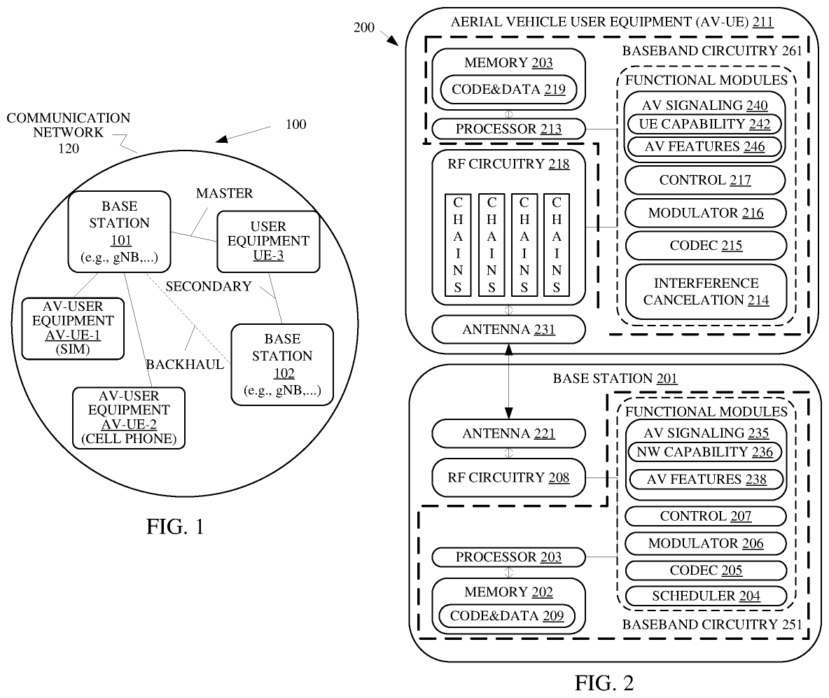

FIG. 1 illustrates a communication network 120 to support communications with aerial vehicles such as the aerial vehicle user equipment AV-UE-1 and AV-UE-2. The communication network 100 is an Orthogonal Frequency Division Multiplex (OFDM) network comprising a primary base station 101, a first user equipment AV-UE-1, a second user equipment AV-UE-2, a third user equipment UE-3, and a secondary base station 102. In a 3GPP system based on an Orthogonal Frequency Division Multiple Access (OFDMA) downlink, the radio resource is partitioned into subframes in time domain and each subframe comprises of two slots. Each OFDMA symbol further consists of a number of OFDMA subcarriers in frequency domain depending on the system bandwidth. The basic unit of the resource grid is called Resource Element (RE), which spans an OFDMA subcarrier over one OFDMA symbol. Resource blocks (RBs) comprise a group of REs, where each RB may comprise, e.g., 12 consecutive subcarriers in one slot.

Several physical downlink channels and reference signals use a set of resource elements carrying information originating from higher layers of code. For downlink channels, the Physical Downlink Shared Channel (PDSCH) is the main data-bearing downlink channel, while the Physical Downlink Control Channel (PDCCH) may carry downlink control information (DCI). The control information may include scheduling decision, information related to reference signal information, rules forming the corresponding transport block (TB) to be carried by PDSCH, and power control command UEs may use cell-specific reference signals (CRS) for the demodulation of control/data channels in non-precoded or codebook-based precoded transmission modes, radio link monitoring and measurements of channel state information (CSI) feedback. The AV-UEs and the UE-3 may use UE-specific reference signals (DM-RS) for the demodulation of control/data channels in non-codebook-based precoded transmission modes.

In some embodiments, the communication network 120, in general, and the base station 101 specifically may control interference by the AV-UEs on the base station 101, other base stations such as the base station 102 and other neighboring base stations, and other UEs such as the terrestrial UE-3 or another AV-UE. Interference control relates to detection and mitigation or avoidance of interference through activation and deactivation of aerial vehicle features as well as monitoring signal strengths at the AV-UEs and at other nodes in the serving cell and in neighboring cells. In several embodiments, the base station 101 may control interference through communications with the AV-UEs through radio resource control (RRC) or PDCCH signaling. For instance, the baseband processing circuitry of the base station 101 may generate and encode, and a physical layer of the base station 101 may transmit RRC messages to the AV-UEs to enable or disable communications with the base station 101, at least temporarily, and may also establish a communications schedule with the AV-UEs.

With regard to detection of interference, the base station 101 may establish periodic or event triggered measurement reports. The baseband processing circuitry of the base station 101 may generate and encode, and a physical layer of the base station 101 may transmit a measurement configuration to each of the AV-UEs to establish the one or more trigger events to cause the AV-UEs to perform measurements and transmit a measurement report. The trigger events may include, for instance, an aggregated interference measurement from multiple cells (N) that exceeds an interference threshold where N and the interference threshold may be configured by the network via, e.g., the base station 101 in the measurement configuration, where the aggregated measurement is a sum of interference measurements of the N cells and where N exceeds a threshold number of cells; an interference ratio based on a serving cell signal, such as the signal from the base station 101, that is above and/or below a threshold for the interference ratio; a height measurement by an AV-UE that is above a threshold or falls within a range of heights; a velocity measurement by the AV-UE that exceeds a velocity threshold at a particular height or within a particular range of heights; a number of detected cells that exceeds a threshold (N) where N is configurable; and a signal from a distant cell or base station that the AV-UE detects where the distance exceeds a threshold or the strength of the signal exceeds a threshold.

For situations in which an AV-UE such as AV-UE-1 detects a distant cell, the base station 101 may activate a trigger event so the communications network 120 can determine if a handover is appropriate. The base station 101 may determine that unusually high strength signals from a distant cell should not prematurely trigger a handover event.

In several embodiments, the base station 101 may also determine scaling factors in relation to measurements by the AV-UEs. For example, the base station 101 may set scaling factors for the time to trigger (TTT) and Layer-3 (L3) filtering to avoid a premature handover. In some embodiments, these AV-UEs can use the scaling factors when aerial vehicle functions are enabled by the communications network 120.

With respect to the TTT, the scaling factor may be multiplied by the current TTT configuration to scale the TTT. For example, if the TTT is 6 seconds, a scaling factor of 0.5 would reduce the TTT by half, which is 3 seconds. In several embodiments, the scaling factors may comprise values of 0.25, 0.5, 0.75, 1.0 to decrease the value of T_reselection which allows more rapid cell re-selections. Use of scaling factors for TTT that are larger than 1.0 may increase the time to trigger a handover.

In some embodiments, L3 filtering may use a formula:

Fn=(1−a)*Fn−1+a*Mn

Where Fn=This is used for measurement reporting and represent updated filtered measurement result; Fn−1 represents the old filtered measurement result, Mn is the latest received measurement result from physical layer; and a is ½\hat{ }(k/4) where k is filter co-efficient, or scaling factor, for corresponding measurement quantity received by the quantity config parameter.

In some embodiments, the AV-UE may apply L3 filtering based on two scaling factors (k): filterCoefficientRSRP and filterCoefficientRSRQ. The default values for these scaling factors may be set so that the L3 filter is not applied and the measurement report uses raw measurement data. If the base station 101 includes one or more scaling factors (k) for, e.g., filterCoefficientRSRP and/or filterCoefficientRSRQ, the L3 filter may be applied to the corresponding measurements for inclusion in the measurement report during, e.g., a handover procedure.

The AV-UEs can use scaling factors as speed state parameters for reselection when in idle mode. In some embodiments, the speed state parameters may adjust one or more measurements for inclusion in the measurement report based on the velocity of the AV-UEs.

The communication network 120 may comprise a cell such as a micro-cell or a macro-cell and the base station 101 may provide wireless service to AV-UEs and UEs within the cell, while the base station 102 may provide wireless service to UEs within another cell located adjacent to or overlapping the cell. In other embodiments, the communications network 120 may comprise a macro-cell and the base station 102 may operate a smaller cell within the macro-cell such as a micro-cell or a picocell. Other examples of a small cell may include, without limitation, a micro-cell, a femto-cell, or another type of smaller-sized cell.

In various embodiments, the base station 101 and the base station 102 may communicate over a backhaul. In some embodiments, the backhaul may comprise a wired backhaul. In various other embodiments, backhaul may comprise a wireless backhaul.

During the initial connection between the radio resource control (RRC) layer of the base station 101 and the AV-UE-1, the baseband processing circuitry of the AV-UE-1 may generate and encode, and a physical layer of the AV-UE-1 may transmit signaling such as an RRCConnectionRequest comprising an identity for the AV-UE-1. In response, the base station 101 may receive the signaling from the AV-UE-1 and determine to transmit a capabilities enquiry (request) such as the UECapabilityEnquiry. In several embodiments, the AV-UE-1 may transmit a response to indicate that the AV-UE-1 is part of an aerial vehicle.

The AV-UEs may be integrated with an aerial vehicle and include a subscriber identity module (SIM) or may be terrestrial user equipment such as a smart phone mounted to an aerial vehicle such as a drone. The SIM may be a physical SIM card or an electronic SIM, such as a Soft SIM, dynamically provisioned with aerial vehicle capabilities referred to herein as aerial vehicle functions that include one or more aerial vehicle features.

In some embodiments, the AV-UE-1 may include at least one bit in the capabilities information to indicate that it is part of an aerial vehicle without distinguishing between an aerial vehicle with a SIM and a user equipment designed for terrestrial use attached to an aerial vehicle to act like, at least temporarily, an AV-UE. In other embodiments, the AV-UE-1 may include at least two bits in the capabilities information to transmit to the base station 101. The first bit may be reserved for a UE that aerial vehicle only and the second bit may be reserved for a user equipment mounted to an aerial vehicle. In the present embodiment, the AV-UE-1 is an aerial vehicle only user equipment so the AV-UE-1 may set the aerial vehicle only bit to, e.g., a logical one, which is the first bit in this embodiment. The AV-UE-2 is a cellular phone mounted to a drone so, in communication of capabilities information with the base station 101, the AV-UE-2 may set the bit for user equipment that acts as an aerial vehicle, which is the second bit in this embodiment.

In still other embodiments, the baseband processing circuitry of the AV-UE-1 may generate and encode, and a physical layer of the AV-UE-1 may transmit the UE capabilities information with at least two bits: a first bit to indicate support by the AV-UE-1 for basic aerial vehicle feature(s) and one or more bits to indicate support by the AV-UE-1 for one or more additional aerial vehicle features. For instance, the AV-UE-1 may transmit, in the capabilities information, a bit to indicate a capability to perform interference nulling. Interference nulling may comprise an aerial vehicle feature, or function, in which the AV-UE-1 may, in response to an indication from the base station 101, apply protection at some angle and/or at certain cells from interference via beamforming transmissions from the AV-UE-1. In several embodiments, the beamforming may involve transmission of waveforms with constructive and destructive interference, the constructive interference to amplify the signals of the transmission towards the intended receiver(s) such as antenna of the base station 101 and the destructive interference to eliminate or attenuate the amplitude of signals traveling in a particular direction that may be defined by an angle towards certain cells for which the base station 101 requested protection.

After receiving a measurement configuration and other configuration such as carrier, channel, modulation and coding rate, and/or pilot subcarrier information from the base station 101, the AV-UE-1 may communicate with the base station 101 to maintain the connection, in response to trigger events, and/or in accordance with a schedule provided by the base station 101. For instance, the communication network 120 and, specifically, the serving base station 101 may be able to enable and disable the AV-UE-1's “aerial vehicle communication status”. Thereafter, the baseband processing circuitry of the base station may allocate aerial vehicle UE specific time frames in which interference to other network (NW) nodes like base stations an UEs can be minimized. Furthermore, the base station 101 may indicate to the AV-UEs to stop communication for some period of time and try again after a particular period of time or at a target time for transmission of a communication.

In several embodiments, data of communications may involve transmissions of subframes of a radio frame for uplink and/or downlink on PCell, SCell, and/or PSCell. For example, AV-UE-1 may support carrier aggregation and non-stand-alone, dual connectivity and communicates with both the base station 101 and the base station 102. Carrier aggregation (CA) may allow the AV-UE-1 to simultaneously transmit and receive data on multiple component carriers to and from the base station 101. Dual connectivity (DC) may allow the AV-UE-1 to simultaneously transmit and receive data on multiple component carrier from two cell groups: the master cell group (MCG) and the secondary cell group (SCG). And non-stand-alone, dual connectivity may allow the AV-UE-1 to simultaneously transmit and receive data on both the wide bandwidth component carrier and a different component carrier.

FIG. 2 illustrates an embodiment of a simplified block diagram 200 of a base station 201 and an aerial vehicle user equipment (AV-UE) 211 that may carry out certain embodiments in a communication network such as the base station 101, the AV-UEs, and communication network 120 shown in FIG. 1. For the base station 201, the antenna 221 transmits and receives radio signals. The RF circuitry 208 coupled with the antenna 221, which is the physical layer of the base station 201, receives RF signals from the antenna 231, converts the signals to digital baseband signals and sends them to the processor 203 of the baseband circuitry 251, also referred to as the processing circuitry or baseband processing circuitry. The RF circuitry 208 also converts received, digital baseband signals from the processor 203, converts them to RF signals, and sends out to antenna 221.

The processor 203 processes the received baseband signals and invokes different functional modules to perform features in the base station 201. The memory 202 stores program instructions or code and data 209 to control the operations of the base station. The processor 203 may also execute code such as RRC layer code from the code and data 209 to configure and implement the aerial vehicle signaling 235 to manage interference of AV-UEs on other nodes, such as base stations and terrestrial UEs in the serving cell of the base station 201 and in neighboring cells.

The aerial vehicle signaling 235 may manage interference with one or more aerial vehicle functions such as network capability 236 and aerial vehicle features 238. The base station 201 communicates with the AV-UE 211 for the communication network so the base station 201 determines which features to enable and disable for the base station 201 and which features to enable and disable for the AV-UE 211. The baseband processing circuitry of the base station 201 may, via an interface coupled with a physical layer of the base station 201, also communicate with the AV-UE 211 via a measurement configuration or measurement reconfiguration to enable and disable features.

Certain cells of the communication network may include specialized support for aerial vehicles. The network capability 236 function of the baseband circuitry 251 may instruct the base station 201 to transmit capability information to the AV-UE 211 that includes a special indicator bit to inform the AV-UE 211 that the base station 201 is part of a ‘preferred aerial vehicle service cell’. Such cells may, in some embodiments, the network capability 236 function may provide a higher priority to AV-UEs to establish a connection, handover to and from the cell, and the like. As a result, the communication network may favor handovers of AV-UEs to such cells.

In further embodiments, the network capability 236 may include logic to instruct the base station 201 to broadcast other cells that support or include specialized support for aerial vehicles to the AV-UE 211 either via dedicated or system information block (SIB) signaling. For instance, baseband processing circuitry of the base station 201 may determine and a physical layer of the base station 201 may transmit information about neighboring cells that include support for aerial vehicles to the AV-UE 211 and/or may broadcast information about neighboring cells that include support for aerial vehicles to all AV-UEs, a group of AV-UEs, and/or to an individual AV-UE.

The aerial vehicle features 238 may include one or more features related to interference control to manage interference by the AV-UE 211 on other nodes but also to manage handovers and the effects of interference at the AV-UE 211. The aerial vehicle features 246 of the aerial vehicle signaling 240 function may include complimentary features to the aerial vehicle features 238. The AV-UE-211 may enable, disable, and perform the aerial vehicle features 246 based on the measurement configuration and other configurations that the AV-UE 211 receives from the base station 201. In some embodiments, the baseband processing circuitry of the base station 201 may, via an interface coupled with a physical layer of the base station 201, include an instruction for the AV-UE in the measurement configuration to transmit a measurement report only if one or more particular trigger events occur. In such embodiments, the AV-UE 211 will only transmit a measurement report in response to the one or more particular trigger events. For instance, baseband processing circuitry of the base station may instruct the AV-UE to only transmit a measurement report if the AV-UE exceeds a height because the AV-UE may act like terrestrial based UEs below that height.

The aerial vehicle features 238 and 246 may include (1) Aerial vehicle interference control; (2) Network aerial vehicle detection; and (3) Interference nulling. The base station 201 and the AV-UE 211 may perform aerial vehicle interference control to avoid and/or mitigate interference on other nodes and to mitigate interference in response to detection of the interference by the base station 201, the AV-UE 211, other nodes in the serving cell, and/or other nodes in neighboring cells. In various embodiments, the aerial vehicle features 238 and 246 of the base station 211 and AV-UE 211, respectively, may include one or more or all the following Aerial vehicle interference control features:
1. The baseband processing circuitry 251 of the base station 201 may, via an interface coupled with a physical layer of the base station 201, enable and disable aerial vehicle “aerial vehicle communication status” by transmitting a signal to an individual AV-UE 211, a group of AV-UEs, and/or to all AV-UEs. In some embodiments, base station 201 may allocate one or more aerial vehicle UE specific time period where interference to other network (NW) nodes can be minimized. In further embodiments, the baseband processing circuitry of the base station 201 may, via an interface coupled with a physical layer of the base station 201, indicate to the AV-UE 211 to stop communication for a time period and/or try again after a time period. The baseband processing circuitry 261 of the AV-UE 211 may receive and decode, via an interface coupled with a physical layer of the AV-UE 211, communications from the base station 201 to enable, disable, one or more aerial vehicle UE specific time period, stop for a time period, or try again after a time period, and implement accordingly.
2. The baseband processing circuitry 251 of the base station 201 may, via an interface coupled with a physical layer of the base station 201, send reduce power indication to the AV-UE 211 for one or more or all communications, for a specific time period, and/or periodically for specific time periods, and/or after the AV-UE 211 sends or in response to the AV-UE 211 sending a measurement report. In some embodiments, the reduce power indication may include a transmission power limit and the indication may instruct the AV-UE 211 to reduce transmission power to a transmission power level that is at or below the transmission power limit. The baseband processing circuitry 261 of the AV-UE 211 may receive and decode, via an interface coupled with a physical layer of the AV-UE 211, communications from the base station 201 with a reduce power indication for one or more or all communications, for a specific time period, and/or periodically for specific time periods, and/or after the AV-UE 211 sends or in response to the AV-UE 211 sending a measurement report. The AV-UE 211 may implement accordingly.
3. The baseband processing circuitry 251 of the base station 201 may, via an interface coupled with a physical layer of the base station 201, stop the periodic sounding reference signal (SRS) configuration for the AV-UE 211 in response to determining that SRS interferes with other cells such as neighbor cells and/or that interference at other cells exceeds a threshold interference measurement such as a signal-to-interference-plus-noise ratio. The baseband processing circuitry 261 of the AV-UE 211 may receive and decode, via an interface coupled with a physical layer of the AV-UE 211, communications from the base station 201 with an instruction to stop the periodic sounding reference signal (SRS) configuration, and implement accordingly.
4. The baseband processing circuitry 251 of the base station 201 may, via an interface coupled with a physical layer of the base station 201, instruct the AV-UE 211 to reduce transmission power for all communications and/or repeat transmissions N times where N is configurable or fixed. Reducing the transmission power for a communication may reduce interference at other nodes but may also increase a bit error rate in communications with the base station 201. By repeating the transmission N times at the lower transmission power level, error correction functionality at the base station 201 may be capable of correcting errors in the communication at the RF circuitry 208 of the base station 201 without having to request that a retransmission of the communication from the AV-UE 211. The baseband processing circuitry 261 of the AV-UE 211 may receive and decode, via an interface coupled with a physical layer of the AV-UE 211, communications from the base station 201 with an instruction to reduce transmission power for all communications and/or repeat transmissions N times where N is configurable or fixed. The AV-UE 211 may implement accordingly.
5. The baseband processing circuitry 251 of the base station 201 may, via an interface coupled with a physical layer of the base station 201, communicate with the AV-UE 211 to implement Aerial vehicle interference control features in radio resource control (RRC) signaling to a dedicated AV-UE, or in a system information block (SIB) broadcast to all the AV-UEs, a group of AV-UEs, or an individual AV-UE such as AV-UE 211. The baseband processing circuitry 261 of the AV-UE 211 may receive and decode, via an interface coupled with a physical layer of the AV-UE 211, communications from the base station 201 with an instruction to implement Aerial vehicle interference control features in radio resource control (RRC) signaling to a dedicated AV-UE, or in a system information block (SIB) broadcast to all the AV-UEs, a group of AV-UEs, or an individual AV-UE such as AV-UE 211. The AV-UE 211 may implement accordingly.
6. In further embodiments, the baseband processing circuitry 251 of the base station 201 may, via an interface coupled with a physical layer of the base station 201, communicate with the AV-UE 211 to implement Aerial vehicle interference control features via the physical downlink control channel (PDCCH). The baseband processing circuitry 261 of the AV-UE 211 may receive and decode, via an interface coupled with a physical layer of the AV-UE 211, communications from the base station 201 to implement Aerial vehicle interference control features via the physical downlink control channel (PDCCH). The AV-UE 211 may implement accordingly.
7. Baseband processing circuitry 251 of the base station 201 may receive, via an interface coupled with a physical layer of the base station 201, a request from the AV-UE 211 to enable and/or disable one or more aerial vehicle features. In response, the base station 201 may respond to the AV-UE 211 with a grant of permission to enable or disable one or more aerial vehicle features and/or a denial of permission to enable or disable one or more aerial vehicle features. The AV-UE 211 may transmit the request and receive communications from the base station 201 with a grant of permission to enable or disable one or more aerial vehicle features and/or a denial of permission to enable or disable one or more aerial vehicle features, and implement accordingly.
8. Baseband processing circuitry 251 of the base station 201 may receive and decode, via an interface coupled with a physical layer of the base station 201, an enabling request comprising a set of optional aerial vehicle features that the AV-UE 211 requests to enable and, in response, the base station 201 may approve or reject the enabling request. The baseband processing circuitry 261 of the AV-UE 211, via an interface coupled with a physical layer of the AV-UE 211, may transmit the enabling request and receive communications from the base station 201 to approve or reject the enabling request, and implement accordingly.
9. Baseband processing circuitry of the base station 201 may determine and a physical layer of the base station 201 may transmit an enabling command to the AV-UE 211 to enable a subset of aerial vehicle features supported by the AV-UE 211 where the base station 201 may receive a list of the aerial vehicle features supported by the AV-UE 211 in the configuration information. The baseband processing circuitry 261 of the AV-UE 211 may receive and decode, via an interface coupled with a physical layer of the AV-UE 211, the enabling command and implement accordingly.
10. The baseband processing circuitry 251 of the base station 201 may, via an interface coupled with a physical layer of the base station 201, request an acknowledgment (ACK) from AV-UE 211 after an “aerial vehicle communication status” is granted. In some embodiments, the base station 201 may include the request in the communication that transmits the grant of the “aerial vehicle communication status”. In other embodiments, the base station 201 may include a request for the ACK in the measurement configuration or other configuration transmitted to the AV-UE 211. For instance, the “aerial vehicle communication status” may relate to a set of communication settings such as transmission power and the AV-UE 211 may determine to request a change in the status to increase or decrease the transmission power of communications based on interference measurements. The baseband processing circuitry 261 of the AV-UE 211 may receive and decode, via an interface coupled with a physical layer of the AV-UE 211, a request for an ACK from the AV-UE 211 after an “aerial vehicle communication status” is granted and transmit the ACK after such a grant accordingly.
11. The baseband processing circuitry 251 of the base station 201 may, via an interface coupled with a physical layer of the base station 201, configure measurement configuration such as interference measurement (such as when the number of detected cells (N) exceeds a threshold number of cells, when the sum of the interference measurements of a number of cells (X) exceeds a threshold interference measurement, or when the sum of the reference signal received powers (RSRPs) of (Y) cells exceeds a threshold where N, X, and Y are configurable by the network and may be different numbers or the same number), height threshold, velocity threshold, height range, geographical location, and the like. The base station 201 may configure measurement configuration for a specific aerial vehicle such as AV-UE 211, a specific type of aerial vehicle based on the capability information from the AV-UE 211, or for all aerial vehicles. Furthermore, the base station 201 may configure the measurement configuration periodically and/or in response to trigger events that cause the AV-UE 211 to transmit measurement reports. The baseband processing circuitry 261 of the AV-UE 211 may receive and decode, via an interface coupled with a physical layer of the AV-UE 211, the measurement configuration from the base station 201 once, more than once, periodically and/or in response to trigger events, and implement accordingly.
12. The baseband processing circuitry 251 of the base station 201 may, via an interface coupled with a physical layer of the base station 201, include, in the measurement configuration and other configurations, new aerial vehicle specific scaling factors for measurement report configuration that may include scaling factors for time to trigger (TTT), Layer-3 (L3) filtering, and the like. The baseband processing circuitry 261 of the AV-UE 211 may, in response, use the scaling factors when aerial vehicle functions such as the aerial vehicle features 246 are enabled by the base station 201 or other node of the communications network. The baseband processing circuitry 261 of the AV-UE 211 may use scaling factors as speed state parameters for one or more measurements for reselection such as when the AV-UE 211 is in idle mode or in response to velocity measurements that exceed one or more velocity thresholds or fall within velocity ranges.
13. New trigger events that the base station 201 may enable or disable and the AV-UE 211 may enable or disable, include:
   a. Interference measurement exceed a threshold. When enabled, the baseband processing circuitry 261 of the AV-UE 211, via an interface coupled with a physical layer of the AV-UE 211, may perform interference measurements of signals from more than one cells and aggregate the interference measurements. If the aggregate of the measurements exceeds a threshold, the baseband processing circuitry 261 of the AV-UE 211 may recognize the measurements as a trigger event and transmit a measurement report to the base station 211 of the current serving cell.
   b. Interference ratio compared with serving cell signal is above/below a threshold. When enabled, the baseband processing circuitry 261 of the AV-UE 211 may perform measurements of signals from the base station 201 of the serving cell, determine a ratio interference to the signal quality such as the reference signal received quality (RSRQ) and/or a signal power such as the reference signal received power (RSRP), and compare the interference ratio(s) with one or more thresholds to determine if the measurement is a trigger event. If the baseband processing circuitry 261 of the AV-UE 211 recognizes the measurements as a trigger event, the baseband processing circuitry 261 of the AV-UE 211, via an interface coupled with a physical layer of the AV-UE 211, may transmit a measurement report to the base station 211 of the current serving cell and baseband processing circuitry of the base station 201 may receive and decode, via an interface coupled with a physical layer of the base station 201, the measurement report.
   c. Measured height is above a threshold. When enabled, perform height measurements based on one or more detection methods or from a reference attitude sent by the base station 201. If the height measurement exceeds a threshold, the baseband processing circuitry 261 of the AV-UE 211 may recognize the measurement as a trigger event and transmit a measurement report to the base station 211 of the current serving cell.
   d. Measurement height is within a range. When enabled, the baseband processing circuitry 261 of the AV-UE 211, via an interface coupled with a physical layer of the AV-UE 211, may perform height measurements based on one or more detection methods. If the height measurement falls within a range or reaches a height that falls within a range, the baseband processing circuitry 261 of the AV-UE 211 may recognize the measurement as a trigger event and transmit a measurement report to the base station 211 of the current serving cell.
   e. Velocity measurement in conjunction with height measurements. When enabled, the baseband processing circuitry 261 of the AV-UE 211, via an interface coupled with a physical layer of the AV-UE 211, may perform velocity measurements and height measurements based on one or more detection methods periodically and/or in accordance with the measurement configuration received from the base station 201. If the velocity measurement in conjunction with the height measurement falls within a range of velocity and heights, exceeds a velocity above or below a height threshold or within a height range, or falls within a velocity range above or below a height threshold, the baseband processing circuitry 261 of the AV-UE 211 may recognize the measurement as a trigger event and send a measurement report to the physical layer of the AV-UE 211 to transmit the measurement report to the base station 211 of the current serving cell.
   f. When number of detected cells exceeds a threshold (N) where N is configurable. (In simulation and field tests it is seen that an AV-UE typically receives signals from many more cells than a ground UE). When enabled, the baseband processing circuitry 261 of the AV-UE 211 may determine the number of cells from which the AV-UE 211 receives signals. If the number of cells exceeds a threshold N, which may be set in the configuration measurement received from the base station 201, the baseband processing circuitry 261 of the AV-UE 211 may recognize the measurement as a trigger event and send a measurement report to the physical layer of the AV-UE 211 to transmit the measurement report to the base station 211 of the current serving cell. Otherwise, in some embodiments, no measurement report is triggered until N cell is satisfied.
   g. When a particular cell such as a distant cell, identified by the base station 201 in the measurement configuration or other configuration, exceeds a threshold. This can help detect a rogue UE starting a flight and seeing a distant cell that a ground UE should not detect as a strong cell. For instance, in a field trial, it was seen that UE handed over to a different cell very far away, which would not have happened for a terrestrial UE at a ground level. When enabled, the baseband processing circuitry 261 of the AV-UE 211 may compare the cells from which the AV-UE 211 receives signals above certain power and/or quality levels with a list of distant cells provided by the base station 201. If the baseband processing circuitry 261 of the AV-UE 211 detects a cell at a quality and/or power that exceeds a threshold, the baseband processing circuitry 261 of the AV-UE 211 may recognize the measurement as a trigger event and send a measurement report to the physical layer of the AV-UE 211 to transmit the measurement report to the base station 211 of the current serving cell.

Note that transmission of measurement reports from the AV-UE 211 to the base station 201 in response to trigger events that report unusual readings such as strong and/or high-quality signals from distant cells or from a number of cells that exceeds a threshold number of cells can provide the base station 201 with information that allows the base station 201 to take various corrective or mitigative actions. For example, baseband processing circuitry of the base station 201 may determine and a physical layer of the base station 201 may transmit a new measurement configuration to adjust the current measurement configuration of the AV-UE 211. In the new measurement configuration, the base station 201 may, e.g., include new or adjusted scaling factors for one or more measurements.

In various embodiments, the aerial vehicle features 238 and 246 of the base station 211 and AV-UE 211, respectively, may include one or more or all the following Network aerial vehicle detection features:
a. The base station 201 of the serving cell may configure uplink (UL) measurement (e.g. SRS) of any aerial vehicle UE such as the AV-UE 211:
   i. Any time;
   ii. When AV-UE requests to enable aerial vehicle feature; and/or
   iii. When the communication network or the base station 201 detects an aerial vehicle behavior such as detection that the AV-UE 211 is in flight or exceeds a height.
b. The AV-UE 211 sends signaling to the base station 201 when one of the following is satisfied:
   iv. Measurement of multiple (N) cells exceed a threshold, N and the threshold is configurable. For example, if the AV-UE 211 transmits a measurement report that indicates that the measurement of N cells exceeds a threshold (either the individually or in aggregate), baseband processing circuitry of the base station 201 may determine and a physical layer of the base station 201 may transmit a communication to the AV-UE 211 to instruct the AV-UE 211 to perform an UL measurement. In response, the baseband processing circuitry 261 of the AV-UE 211 may receive and decode, via an interface coupled with a physical layer of the AV-UE 211, the instruction and transmit a reference signal to one or more base stations of one or more cells to measure the UL interference for the one or more cells and transmit a measurement report for the interference at the AV-UE 211 for signals from each of the one or more cells.
   v. Height and/or velocity with height exceed a threshold and the height and threshold may be configurable. The AV-UE 211 may send a measurement report to a physical layer of the AV-UE 211 to transmit the measurement report to the base station 201 of the serving cell and include the current height and/or velocity information. For instance, the AV-UE 211 may transmit an information element in the measurement report that includes the current height and/or velocity information. In some embodiments, the baseband processing circuitry 261 of the AV-UE 211 may optionally include location information such as three-dimensional (3D) positioning via systems such as a global positioning system (GPS), a BeiDou, a Glonass system, a Galileo system, a Barometric pressure sensor, a wireless local area network (WLAN), and a metropolitan beacon system (MBS), and the like. Some reference of the technologies are as follows:
   1. Global Navigation Satellite System (GNSS) receivers, using, e.g., the GPS, GLONASS, Galileo or BeiDou system: The baseband processing circuitry 261 of the AV-UE 211 may receive and decode, via an interface coupled with a physical layer of the AV-UE 211, signals from at least 4 satellites and either calculate the position and velocity information or provide the data to the base station 201 so the baseband processing circuitry 251 of the base station 201 may, via an interface coupled with a physical layer of the base station 201, calculate or otherwise determine the 3D position and the velocity of the AV-UE 211.
   2. Barometric pressure sensor: the baseband processing circuitry 261 of the AV-UE 211 may measure the barometric pressure and determine, optionally in conjunction with other information, a height of the 3D position of the AV-UE 211.
   3. WLAN: The baseband processing circuitry 261 of the AV-UE 211 may determine the 3D position based on the LLA (Latitude Longitude Altitude) information of the MB S transmitters that a location server of the communication network provides to AV-UE 211 via the base station 201 in conjunction with other information.
   4. MBS: The baseband processing circuitry 261 of the AV-UE 211 may determine the 3D position based on the LCI (Location Configuration Information) information of the WLAN access points (APs) that a location server of the communication network provides to AV-UE 211 via the base station 201, in conjunction with other information.
c. The base station 201 of the serving cell may send an aerial vehicle region map to the AV-UE 211 upon connection to indicate to the AV-UE 211 an area of the aerial vehicle region map in which interference control may be applied. In other words, the base station 211 may include the indication of an area of the map as well as one or more interference control features that the baseband processing circuitry 261 of the AV-UE 211, via an interface coupled with a physical layer of the AV-UE 211, may apply in response to entering the area of the map.
   vi. When the AV-UE 211 detects it is in the high interference density region, the AV-UE 211 may be required to perform measurement and transmit a measurement report; limit transmission power to a configured maximum power (reduced power) from the measurement configuration; and/or signal to the base station 201 that the AV-UE 211 has entered in the region and wait for additional signaling from the base station 201. Waiting for additional signaling may, in some embodiments, involve halting transmissions until the AV-UE 211 receives a new measurement configuration or other configuration or instruction from the base station 201 of the serving cell.
   vii. Some measurement events configured by base station 201, such as a trigger event or periodic event, may trigger an aerial vehicle such as AV-UE 211 to perform one or more interference avoidance functions, that may be predefined in the measurement configuration or other configuration, instead of or in addition to triggering a measurement report. The exit criteria of the measurement configuration may bring the aerial vehicle out of the one or more interference avoidance functions. For example, an exit criterion may include exiting a region of the map that is identified as a high-density area. In some embodiments, one or more of the trigger events may be exit criteria such as a height measurement being within a height range, a velocity measurement being within a velocity range, an interference measure from one or more cells (individually or in aggregate) falling below a threshold, and/or the like.

In various embodiments, the aerial vehicle features 238 and 246 of the base station 211 and AV-UE 211, respectively, may include one or more or all the following Interference nulling features:
a. When a communication network experiences high interference from an AV-UE such as the AV-UE 211, a base station of the serving cell such as the base station 211 may transmit an indication to the AV-UE to apply protection in terms of interference or lower interference by beamforming (e.g. nulling) at some angle or to some cells where the interference is detected. For example, the baseband processing circuitry 261 of the AV-UE 211 may receive and decode, via an interface coupled with a physical layer of the AV-UE 211, an instruction from the base station 201 to block out or mitigate transmission at a 30-degree angle because, e.g., another base station detects interference from the AV-UE 211 and that base station is at a 30-degree angle from the AV-UE 211 transmitter. In response, the baseband processing circuitry 261 of the AV-UE 211 may identify the 30-degree angle of transmission to block and, via the physical layer of the AV-UE 211, perform beamforming to form destructive interference to attenuate or eliminate the power of signals transmitted at the 30-degree angle of transmission. In some embodiments, the baseband processing circuitry 251 and/or 261 may determine the 30-degree angle based on the angle of declination from the AV-UE 211 to the base station 201.
b. The baseband processing circuitry 261 of the AV-UE 211, via an interface coupled with a physical layer of the AV-UE 211, may perform measurement and apply nulling during transmission when a measurement of interference in certain a direction exceeds a threshold. In other words, the AV-UE 211 may identify a trigger event based on an interference measurement for a certain direction and implement nulling based on a measurement configuration received from the base station 201 and/or a default configuration that automatically applies this aerial vehicle feature is enabled.

The RRC layer code, when executed on a processor such as the processor 203, may determine if the AV-UE 211 requires interference control and may enable/disable, and/or instruct the AV-UE 211 to perform a measurement and transmit a measurement report. In further embodiments, the base station 201 may instruct the AV-UE 211 to perform one or more of the other interference control features based on capabilities that the AV-UE 211 transmits to the base station 201.

A similar configuration exists in AV-UE 211 where the antenna 231 transmits and receives RF signals. The RF circuitry 218 coupled with the antenna, which is the physical layer of the AV-UE 211, receives RF signals from the antenna 221, converts them to baseband signals and sends them to processor 213 of the baseband circuitry 261, also referred to as the processing circuitry or baseband processing circuitry. The RF transceiver 218 also converts received baseband signals from the processor 213, converts them to RF signals, and sends out to the antenna 231.

The RF circuitry 218 illustrates multiple RF chains. While the RF circuitry 218 illustrates five RF chains, each UE may have a different number of RF chains and each of the RF chains in the illustration may represent multiple, time domain, receive (RX) chains and transmit (TX) chains. The RX chains and TX chains include circuitry that may operate on or modify the time domain signals transmitted through the time domain chains such as circuitry to insert guard intervals in the TX chains and circuitry to remove guard intervals in the RX chains. For instance, the RF circuitry 218 may include transmitter circuitry and receiver circuitry, which is often called transceiver circuitry. The transmitter circuitry may prepare digital data from the processor 213 for transmission through the antenna 231. In preparation for transmission, the transmitter may encode the data, and modulate the encoded data, and form the modulated, encoded data into Orthogonal Frequency Division Multiplex (OFDM) and/or Orthogonal Frequency Division Multiple Access (OFDMA) symbols. Thereafter, the transmitter may convert the symbols from the frequency domain into the time domain for input into the TX chains. The TX chains may include a chain per subcarrier of the bandwidth of the RF chain and may operate on the time domain signals in the TX chains to prepare them for transmission on the component subcarrier of the RF chain. For wide bandwidth communications, more than one of the RF chains may process the symbols representing the data from the baseband processor(s) simultaneously.

The processor 213 processes the received baseband signals and invokes different functional modules to perform functions including the UE capability 242 and the aerial vehicle features 246 in the AV-UE 211. The UE capability 242 may, in response to a request from the base station 201, transmit information the aerial vehicle features that the AV-UE 211 supports.

The memory 212 stores program instructions or code and data 219 to control the operations of the AV-UE 211. The processor 213 may also execute medium access control (MAC) layer code of the code and data 219. For instance, if the AV-UE 211 performs interference measurements, the MAC layer code may execute on the processor 213 to perform the measurements on signals via the physical layer (PHY), which is the RF circuitry 218 and associated logic such as the functional modules. In such embodiments, the MAC layer code may complete the measurement and resume communications via the corresponding one or more RF chains.

To illustrate for E-UTRAN FDD intra frequency measurements, the baseband processing circuitry 261 of the AV-UE 211, via an interface coupled with a physical layer of the AV-UE 211, may be able to identify new intra-frequency cells and perform RSRP, RSRQ, and RS-SINR measurements of identified intra-frequency cells without an explicit intra-frequency neighbour cell list containing physical layer cell identities. During the RRC_CONNECTED state, the baseband processing circuitry 261 of the AV-UE 211, via the physical layer of the AV-UE 211, may continuously measure identified intra frequency cells and additionally search for and identify new intra frequency cells. Furthermore, in the RRC_CONNECTED state, the measurement period for intra frequency measurements may be, e.g., 200 milliseconds (ms). In some embodiments, the AV-UE 211 may be capable of performing RSRP, RSRQ, and RS-SINR measurements for 8 identified-intra-frequency cells, and the AV-UE 211 physical layer (PHY) may be capable of reporting measurements to higher layers with the measurement period of, e.g., 200 ms. If the AV-UE 211 has identified more than the particular number of cells, the AV-UE 211 may perform measurements of at least 8 identified intra-frequency cells but the reporting rate of RSRP, RSRQ, and RS-SINR measurements of cells from AV-UE 211 physical layer to higher layers may be decreased.

The base station 201 and the AV-UE 211 may include several functional modules and circuits to carry out some embodiments. The different functional modules may include circuits or circuitry that code, hardware, or any combination thereof, can configure and implement. For example, the processor 203 (e.g., via executing program code 209) may configure and implement the circuitry of the functional modules to allow the base station 201 to schedule (via scheduler 204), encode (via codec 205), modulate (via modulator 206), and transmit control information and data (via control circuit 207) to the AV-UE 211.

The processor 213 (e.g., via executing program code 219) may configure and implement the circuitry of the functional modules to allow the AV-UE 211 to receive, de-modulate (via de-modulator 216), and decode (via codec 215) the control information and data (via control circuit 217) accordingly with an interference cancelation (IC 214) capability.

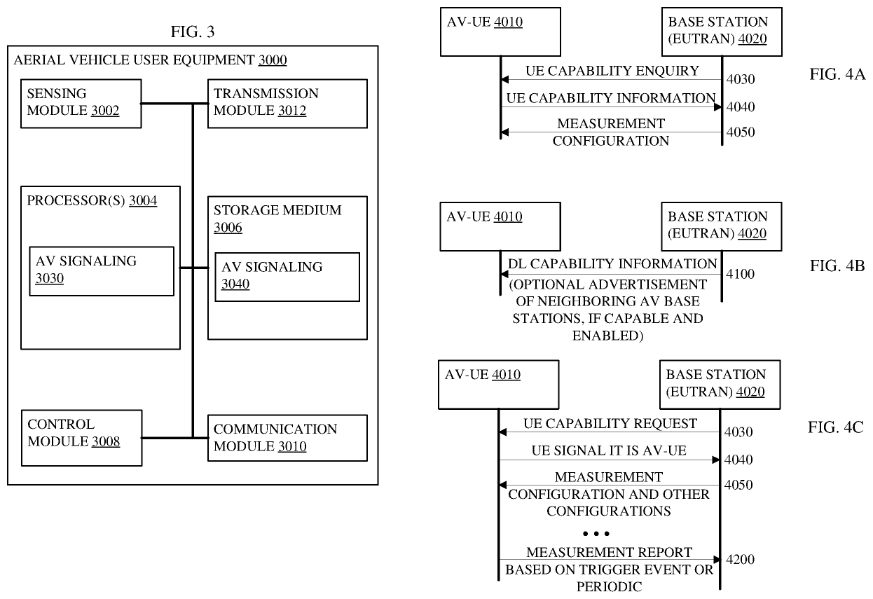

FIG. 3 depicts an embodiment for an aerial vehicle user equipment (AV-UE) 3000 such as the AV-UE-1 and AV-UE-2 in FIG. 1 and the AV-UE 211 in FIG. 2. The AV-UE 3000 may control a movable object, in accordance with embodiments. The AV-UE 3000 can combine with any suitable embodiment of the systems, devices, and methods disclosed herein. The AV-UE 3000 can include a sensing module 3002, processor(s) 3004, a non-transitory storage medium 3006, a control module 3008, and communication module 3010. Each of these modules include circuitry to implement logic such as code and can also be referred to as processing circuitry or logic circuitry.

The sensing module 3002 may use several types of sensors that collect information relating to the movable objects in several ways. Distinct types of sensors may sense several types of signals or signals from different sources. For example, the sensors can include inertial sensors, GPS sensors, proximity sensors (e.g., lidar), or vision/image sensors (e.g., a camera). The sensing module 3002 can operatively couple to a processor(s) 3004. In some embodiments, the sensing module 3002 can operatively couple to a transmission module 3012 (e.g., a Wi-Fi image transmission module) to directly transmit sensing data to a suitable external device or system. For example, the transmission module 3012 can transmit images captured by a camera of the sensing module 3002 to a remote terminal.

The processor(s) 3004 may comprise one or more processors, such as a programmable processor (e.g., a central processing unit (CPU)). The processor(s) 3004 may comprise processing circuitry to implement aerial vehicle signaling 3030 such as the aerial vehicle signaling 240 discussed in conjunction with in FIG. 2. The aerial vehicle signaling 3030 may comprise code executing within the processor(s) 3004 and may comprise a portion of or all the code included in the aerial vehicle signaling 3040 in the storage medium 3006. In some embodiments, the aerial vehicle signaling 3040 may reside on a physical subscriber identification module (SIM) card or a Soft SIM. In other embodiments, the aerial vehicle signaling 3040 may comprise code residing on a terrestrial user equipment to adapt the equipment to operate as an aerial vehicle user equipment. For example, the AV-UE 3000 may periodically determine a height measurement and velocity measurement for AV-UE 3000. If the height measurement and/or velocity measurement in conjunction with the height measurement exceed a threshold set by a base station or that is a default setting or preference setting, the AV-UE 3000 may generate a measurement report that includes an information element with 3D position information about the AV-UE 3000 and transmit the measurement report to the base station with which the AV-UE 3000 is currently connected. The processor(s) 3004 may operatively couple with a non-transitory storage medium 3006.

The non-transitory storage medium 3006 may store logic, code, and/or program instructions executable by the processor(s) 3004 for performing one or more instructions including the aerial vehicle signaling 3040 such as the aerial vehicle signaling 240 discussed in conjunction with in FIG. 2. The non-transitory storage medium may comprise one or more memory units (e.g., removable media or external storage such as a secure digital (SD) card or random-access memory (RAM)). In some embodiments, data from the sensing module 3002 transfers directly to and stores within the memory units of the non-transitory storage medium 3006. The memory units of the non-transitory storage medium 3006 can store logic, code and/or program instructions executable by the processor(s) 3004 to perform any suitable embodiment of the methods described herein. For example, the processor(s) 3004 may execute instructions causing one or more processors of the processor(s) 3004 to analyze sensing data produced by the sensing module. The memory units may store sensing data from the sensing module 3002 for processing by the processor(s) 3004. In some embodiments, the memory units of the non-transitory storage medium 3006 may store the processing results produced by the processor(s) 3004.

In some embodiments, the processor(s) 3004 may operatively couple to a control module 3008 to control a state of the movable object. For example, the control module 3008 may control the propulsion mechanisms of the movable object to adjust the spatial disposition, velocity, and/or acceleration of the movable object with respect to six degrees of freedom. Alternatively, or in combination, the control module 3008 may control one or more of a state of a carrier, payload, or sensing module.

The processor(s) 3004 may couple to a communication module 3010 to transmit and/or receive data from one or more external devices (e.g., a terminal, display device, or other remote controller). For example, the communication module 3010 may implement one or more of local area networks (LAN), wide area networks (WAN), infrared, radio, Wi-Fi, point-to-point (P2P) networks, telecommunication networks, cloud communication, and the like. In some embodiments, communications may or may not require line-of-sight. The communication module 3010 can transmit and/or receive one or more of sensing data from the sensing module 3002, processing results from the processor(s) 3004, predetermined control data, user commands from a terminal or remote controller, and the like.

The components of the AV-UE 3000 can be arranged in any suitable configuration. For example, one or more of the components of the AV-UE 3000 can be located on the movable object, carrier, payload, terminal, sensing system, or an additional external device in communication with one or more of the above.

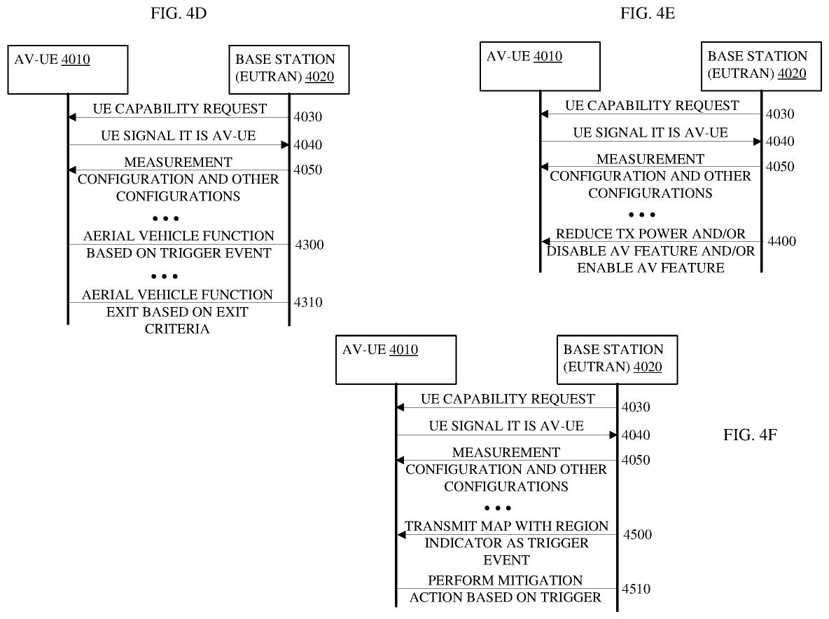

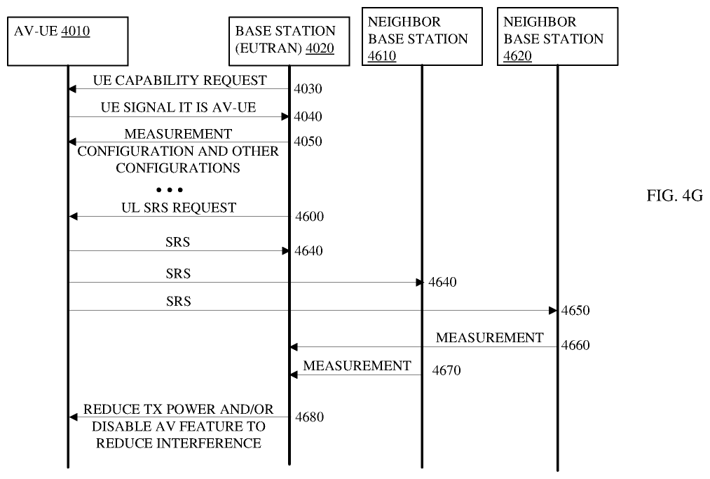

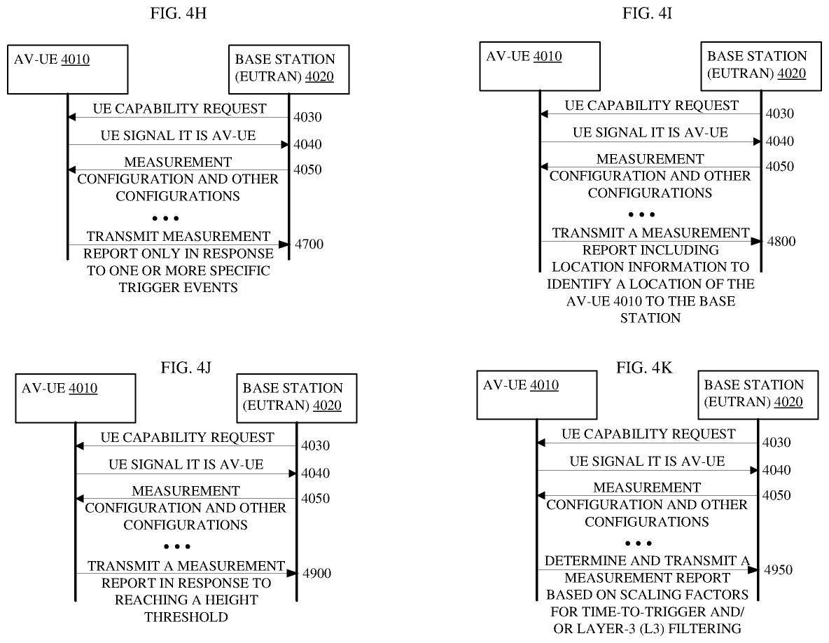

FIGS. 4A-4K depict embodiments of communications between an aerial vehicle user equipment 4010 and a base station 4020, such as the user equipment and base stations shown in FIGS. 1-3. The base station 4020 is part of a E-UTRAN and executes code and protocols E-UTRA. The E-UTRA may include the radio resource management (RRM) in a RRC layer and the RRM may determine a measurement report configuration for an AV-UE 4010.

In FIG. 4A, the base station 4020 may transmit a UE capability enquiry message 4030 to the AV-UE 4010 to request capability information. The AV-UE 4010 may respond to the request with a UE capability information message 4040 and, based on the capability information, the base station 4020 may transmit a measurement configuration message 4050. For instance, the base station 4010 may detect the AV-UE 4010 and request the capability information so that the base station 4020 can determine which aerial vehicle features should be enabled or disabled as well as other configurations related to mitigation of interference on other nodes in the cell and possibly also in neighboring cells.

In FIG. 4B, the base station 4020 may transmit a DL capability information message 4100 to the AV-UE 4010. The DL capability information message may include an aerial vehicle service cell indication. In some embodiments, certain cells might be specialized to support aerial vehicle while other cells are not. The base station 4020 may transmit a DL capability information message that includes a special indicator bit to signal to the AV-UE 4010 so that it knows the cell of the base station 4020 is a ‘preferred aerial vehicle service cell’ that may offer higher priority for AV-UEs for one or more services such as connection, handover, and the like. In further embodiments, the base station 4020 may broadcast or advertise other cells to the AV-UE 4010 that support aerial vehicle services. In other embodiments, the base station 4020 may broadcast or advertise other cells to the AV-UE 4010 either via dedicated or system information block (SIB) signaling.

In FIG. 4C, the AV-UE 4010 may receive a measurement configuration that establishes a periodic and/or event triggered transmission of a measurement report by the AV-UE 4010. After receiving the measurement configuration, the AV-UE 4010 may measure interference and transmit a measurement report 4200 to the base station 4020 of the serving cell. For example, the event triggers may involve a height measurement that the AV-UE 4010 compares against a height threshold or range, an aggregation of interference measurements across more than one cells that the AV-UE 4010 compares against a threshold, a velocity measurement that the AV-UE 4010 compares against a threshold, a velocity and height measurement that compares the height against a height threshold that is associated with the velocity measurement, and/or the like.

In FIG. 4D, the AV-UE 4010 may receive a measurement configuration that establishes an event triggered implementation of an aerial vehicle function by the AV-UE 4010 such as the aerial vehicle functions described in the functional module, aerial vehicle signaling 240 shown in FIG. 2. After receiving the measurement configuration, the AV-UE 4010 may measure downlink interference and detect the trigger event such as a measurement of signals from one or more nodes for N cells in which the number of cells, N, exceeds a threshold number of cells. In response, the AV-UE 4010 may perform the aerial vehicle function 4300 of periodically transmitting a reference signal such as an SRS to one or more of or all the N cells. The corresponding nodes of the cells may send measurement reports to the base station 4020 as the station connected to the AV-UE 4010 and the base station 4020 may determine if and which additional interference control actions to perform.

After initiating the aerial vehicle function 4300, the AV-UE 4010 may monitor for and detect one or more exit criteria 4310 to end the periodic transmission of the reference signals to the cells. For instance, the one or more exit criteria may comprise waiting for an indication from the base station 4020; transmitting periodically until completion of X transmissions; transmitting periodically until the number of cells, N, falls below the threshold value for N; transmitting periodically until a height measurement for the AV-UE 4020 fall below a threshold height and/or rises above a threshold height; transmitting periodically until a velocity of the AV-UE 4010 falls below a threshold velocity or speed and/or exceeds a threshold velocity or speed; or the like.

In FIG. 4E, the base station 4020 may transmit an instruction 4400 to reduce transmission power, disable an aerial vehicle feature, and/or enable an aerial vehicle feature. For example, the base station 4020 may receive a measurement report from a node within the serving cell or neighboring cell that indicates interference from the AV-UE 4010 on one or more nodes. In response, the base station 4020 may determine that the AV-UE 4010 should reduce transmission power to a power limit. After determining that the AV-UE 4010 should reduce transmission power to a power limit, the base station 4020 may transmit an instruction 4400 to the AV-UE 4010 to reduce transmission power for all transmissions or for certain types of transmissions for a time period, indefinitely until otherwise instructed, until the AV-UE 4010 changes direction, height, and/or velocity in accordance with one or more exit criteria, and/or the like.

In FIG. 4F, the base station 4020 may transmit a map 4500 with a region indicator as a trigger event to the AV-UE 4010. For example, the base station 4020 may disable one or more aerial vehicle features and instruct the AV-UE 4010 to remain in the reduced transmission power mode or state with the aerial vehicle features disabled until exiting the region indicator on the map (an exit criterion). In response, the AV-UE 4010 may disable one or more aerial vehicle features and enter the reduced transmission power mode. After determining that the AV-UE 4010 exited the region indicator on the map, the AV-UE 4010 may detect the change as an exit criterion and, in response, enable the one or more aerial vehicle features and resume normal/default transmission power communications.

In FIG. 4G, the base station 4020 may transmit an uplink (UL) sounding reference signals (SRS) request 4600 to the AV-UE 4010. The AV-UE 4600 may respond by transmitting the SRS 4640 to the base station 4020 of the serving cell, transmitting the SRS 4640 to a neighbor base station 4610 in a first neighboring cell, and transmitting the SRS 4650 to the neighbor base station 4620 of another neighboring cell.

The neighbor base station 4610 in the first neighboring cell may transmit a measurement 4660 to the base station 4020 and the neighbor base station 4620 in the second neighboring cell may transmit a measurement 4670 to the base station 4020. Based on the measurements 4660 and 4670 from the neighbor base stations 4610 and 4620, respectively, as well as measurements by the base station 4020, the base station 4020 may determine one or more interference control measures 4680 to mitigate interference to the nodes of the serving cell and neighboring cells such as disabling periodic SRS transmissions for UL interference measurement, reducing transmission power, and/or interference nulling to mitigate the interference at one or both of the neighboring cells. In one embodiment, the base station 4020 may disable communication from the AV-UE 4010 until the base station 4020 establishes a periodic AV-UE contention window or restricted access window for one or more of the AV-UEs in the serving cell.

In FIG. 4H, the base station 4020 may transmit a measurement configuration and other configurations 4050 that instructs the AV-UE 4010 to transmit a measurement report to the base station 101 only in response to a specific set of one or more trigger events such as reaching a specific height or height range, reaching a velocity at or above a specific height or below a specific height, or the like. The AV-UE 4010 may transmit a measurement report only in response to detection of at least one of the one or more specific trigger events 4700.

In FIG. 4I, the base station 4020 may transmit a measurement configuration and other configurations 4050 that instructs the AV-UE 4010 to transmit a measurement report to the base station 101 that includes location information to identify a location of the AV-UE 4010. The AV-UE 4010 may transmit a measurement report with the location information 4800. For example, the AV-UE 4010 may determine a 3-D location for the AV-UE 4010 via systems such as a global positioning system (GPS), a BeiDou, a Glonass system, a Galileo system, a Barometric pressure sensor, a wireless local area network (WLAN), and a metropolitan beacon system (MBS), and the like. Based on the indication in the measurement configuration, the AV-UE 4010 may include a 3-D location of the AV-UE 4010 in the measurement report.

In FIG. 4J, the base station 4020 may transmit a measurement configuration and other configurations 4050 that instructs the AV-UE 4010 to transmit a measurement report to the base station 101 in response to the AV-UE 4010 detecting a height measurement that exceeds a height threshold provided in the measurement configuration. The AV-UE 4010 may transmit a measurement report in response to detection of the height measurement and a determination that the height measurement exceeds the height threshold 4900.

In FIG. 4K, the base station 4020 may transmit a measurement configuration and other configurations 4050 that includes one or more scaling factors for the time-to-trigger (TTT) and/or the Layer-3 (L3) filtering and instructs the AV-UE 4010 to use the scaling factors. In some embodiments, the base station 4020 may establish trigger events for the use of one or more scaling factors such as a height threshold and/or a velocity threshold. The AV-UE 4010 may implement the scaling factors for measurements of, e.g., the RSRP and/or the RSRQ, and transmit a measurement report with measurements based on the scaling factors 4950.

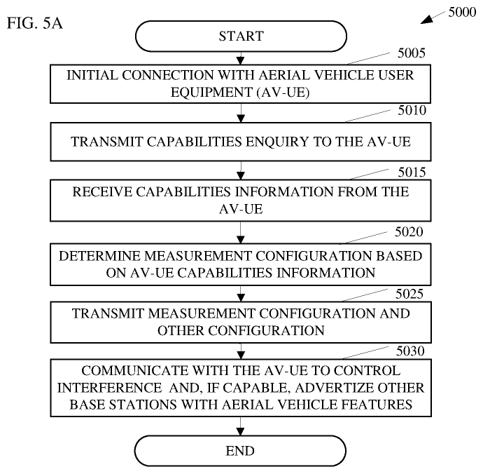

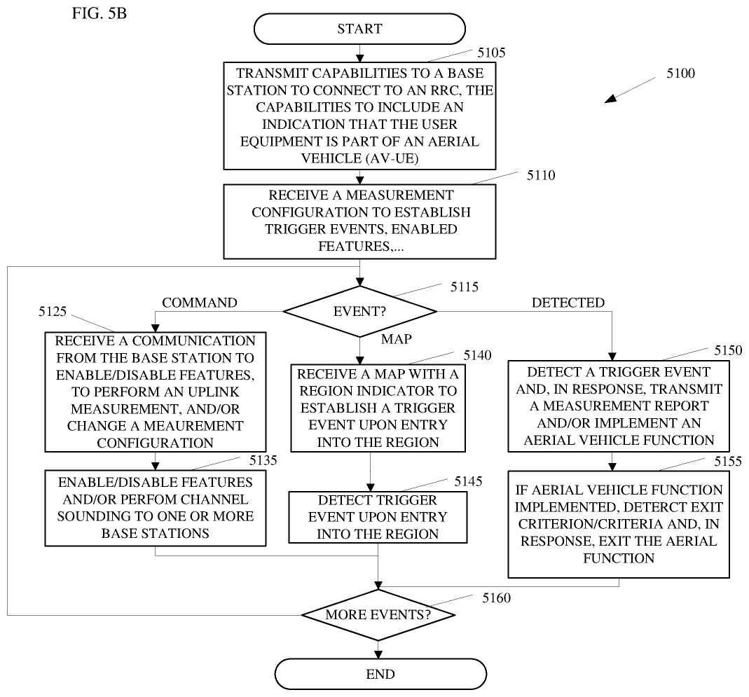

FIGS. 5A-B depict embodiments of flowcharts to signal capability and interference control for a base station and an aerial vehicle user equipment (AV-UE), such as the base station and AV-UE shown in FIGS. 1-4G. FIG. 5A illustrates an embodiment of a flowchart 5000 to establish communications between a base station and a user device such as an aerial vehicle user equipment (AV-UE). At the beginning of the flowchart 5000, the base station may form an initial connection with the AV-UE (element 5005). For example, the baseband processing circuitry of the AV-UE may encode and a physical layer of the AV-UE may transmit a request to establish a connection to the base station such as an initial communication to connect to the RRC layer of the base station and the base station may transmit a synchronization signal to the AV-UE so the AV-UE can measure the synchronization signal and synchronize to a channel. In some embodiments, the AV-UE may synchronize multiple RF chains or a single RF chain to support wide or very wide bandwidth communications.

The baseband processing circuitry of the base station may generate and encode, and a physical layer of the base station may transmit a capabilities enquiry to request capabilities information from the AV-UE (element 5010) and may receive the capabilities information from the AV-UE in response to the request (element 5015). For instance, the baseband processing circuitry of the AV-UE may generate and encode, and a physical layer of the AV-UE may transmit an RRC layer message or message with an information element that includes information about the capabilities of the AV-UE. The information about the capabilities may include information to indicate aerial vehicle functions that the AV-UE supports such as the aerial vehicle functions described with respect to FIGS. 1-4G.

Based on the capabilities information, the base station may determine a measurement configuration (element 5020) that includes configurating, and enabling or disabling a set of aerial vehicle features based on the density of nodes in the cell of the base station. The base station may, with the measurement configuration, instruct the AV-UE to enable an aerial vehicle feature to perform periodic channel sounding to the serving cell and possibly other cells within range to determine if transmissions and/or at what point the transmissions might interfere with nodes in the serving cell and neighbor cells.

After determining a measurement configuration based on the AV-UE capabilities information, the baseband processing circuitry of the base station may generate and encode, and a physical layer of the base station may transmit the measurement configuration and other configuration to the AV-UE (element 5025) and may continue to communicate with the AV-UE to control interference and advertise other cells and/or base stations that include specialized support for AV-UEs (element 5030). For example, the base station may monitor downlink interference by enabling aerial vehicle features for event triggered and/or period measurement reports. If the measurement report indicates interference at the AV-UE, the base station may request that the AV-UE perform a channel sounding to check for interference with base stations or other nodes within one or more cells. In some embodiments, if the base station begins to detect interference at nodes or the AV-UE rises above a threshold height, the base station may instruct the AV-UE to disable periodic channel sounding, reduce transmission power and increase the number of repetitions of communications data to improve reception of the lower power transmissions.

FIG. 5B illustrates an embodiment of a flowchart 5100 for an AV-UE to communicate with a base station to signal capabilities and interference control such as the user equipment (UE) and base station in FIGS. 1-5B. The flowchart 5100 begins with the user device transmitting capabilities to a base station to connect to an RRC, the capabilities to include an indication that the user equipment is part of an aerial vehicle (AV-UE) (element 5105). The capabilities may include a bit to identify whether or not the AV-UE is an aerial vehicle and that, when set, indicates that the AV-UE comprises one or more or a basic set of aerial vehicle features. In other embodiments, the capabilities information may include two bits to identify if the AV-UE is an aerial vehicle and a type of aerial vehicle. For example, the first bit may be set by the AV-UE is the AV-UE is an aerial vehicle only UE. In such embodiments, the AV-UE may include a SIM that includes aerial vehicle functions including one or more aerial vehicle features. On the other hand, the first bit may be a logical zero and the second bit may be set to indicate that the AV-UE is a terrestrial certified user equipment, such as a cellular phone, that is acting as an AV-UE.

After transmitting the capabilities information, the AV-UE may receive a measurement configuration and other configuration to establish trigger events, enabled features, disabled features, triggered aerial functions, periodic measurement reporting, and the like (element 5110). Once the AV-UE establishes an initial measurement configuration, the AV-UE may monitor for detected or periodic trigger events, map trigger events, and command trigger events from the base station (element 5115).

With respect to the command trigger event, the AV-UE may receive a command from the base station to enable and/or disable aerial vehicle features, to perform channel sounding to one or more base stations, and/or to change a measurement configuration (element 5125). In response, the AV-UE may enable and/or disable aerial vehicle features, to perform channel sounding to one or more base stations, and/or to change a measurement configuration (element 5135). For example, the baseband processing circuitry of the base station may generate and encode, and a physical layer of the base station may transmit an instruction to change a measurement configuration such as an interference measurement, a height threshold, a height range, a velocity threshold, a velocity range, a scaling factor for a time-to-trigger (TTT), a scaling factor for Layer-3 (L3) filtering, and/or the like and the AV-UE may comply by performing the configuration change. The base station may transmit such as a command to a specific AV-UE, a group of AV-UEs, or all AV-UEs to adjust interference control for the AV-UE(s) based on interference conditions detected by the communications network and/or measurement reports received from the AV-UE(s).

With respect to the map trigger event, the AV-UE may receive a map with a region indicator to establish a trigger event based on entry into the region (element 5140). In response, the AV-UE may monitor the position of the AV-UE to detect when the AV-UE enters the area marked by the region indicator (element 5145). For example, the base station may determine that an area marked by the region indicator is a dense region for node communications and may determine that once the AV-UE enters that area marked by the region indicator, the AV-UE should adjust the interference mitigation measures. In some embodiments, the base station may provide instructions for mitigation of interference by the AV-UE that are based on the height and/or velocity of the AV-UE. In several embodiments, the base station may provide instructions for mitigation of interference by the AV-UE that are based on number of cells from which the AV-UE receives signals or at least signals that exceed a certain power threshold. In further embodiments, the base station may increase the frequency of period measurement reports or instruct the AV-UE to transmit periodic measurement reports and continue to monitor interference to determine if further interference control actions should be taken.

With respect to the detected or periodic trigger events, the AV-UE may detect a trigger event and, in response, transmit a measurement report and/or implement an aerial vehicle function (element 5150). Furthermore, if the measurement configuration instructs the AV-UE to perform an aerial vehicle function in response to the trigger event, the measurement configuration may also include one or more exit criteria. In such embodiments, the AV-UE may monitor for and detect an exit criterion or more than one exit criteria and, in response, exit the aerial vehicle function (element 5155). For example, the measurement configuration may include a height threshold along with an instruction to transmit a measurement report once the AV-UE exceeds the height threshold. In such embodiments, the base station may set the height threshold at an elevation that the AV-UE might begin to receive more interference from nodes due to having direct line-of-sight to more nodes. Thus, if the measurement report triggered by exceeding the height threshold includes an interference measurement that exceeds an interference threshold, the base station may instruct the AV-UE to perform addition aerial vehicle functions. For instance, the base station may instruct the AV-UE to perform addition aerial vehicle functions to gain more information about the interference and/or to perform actions to mitigate interference that the AV-UE might cause to nearby nodes such as channel sounding to the base station of the serving cell as well as neighboring base stations and reducing transmission power for communications. In some embodiments, the exit criterion may include an interference measurement that is below a threshold such as a ratio of the signal strength of the serving cell to interference plus noise. In other embodiments, the instruction to implement an aerial vehicle instruction does not include an exit criterion.

After processing an event trigger, the AV-UE may continue to monitor for more events (element 5160). In such embodiments, the flowchart 5100 may return to the element 5115.

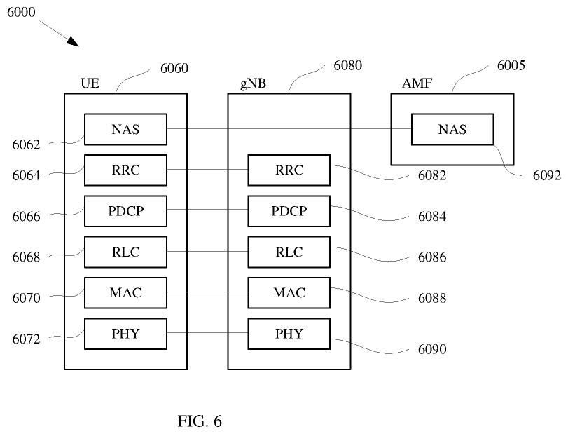

FIG. 6 depicts an embodiment of protocol entities 6000 that may be implemented in wireless communication devices, including one or more of a user equipment (UE) 6060 such as the AV-UEs shown in FIGS. 1-5B, a base station, which may be termed an evolved node B (eNB), or new radio node B (gNB) 6080, such as the base stations shown in FIGS. 1-5B, and a network function, which may be termed a mobility management entity (MME), or an access and mobility management function (AMF) 6094, according to some aspects.

According to some aspects, gNB 6080 may be implemented as one or more of a dedicated physical device such as a macro-cell, a femto-cell or other suitable device, or in an alternative aspect, may be implemented as one or more software entities running on server computers as part of a virtual network termed a cloud radio access network (CRAN).

According to some aspects, one or more protocol entities that may be implemented in one or more of UE 6060, gNB 6080 and AMF 6094, may be described as implementing all or part of a protocol stack in which the layers are considered to be ordered from lowest to highest in the order physical layer (PHY), medium access control (MAC), radio link control (RLC), packet data convergence protocol (PDCP), radio resource control (RRC) and non-access stratum (NAS).

According to some aspects, one or more protocol entities that may be implemented in one or more of UE 6060, gNB 6080 and AMF 6094, may communicate with a respective peer protocol entity that may be implemented on another device, using the services of respective lower layer protocol entities to perform such communication.

According to some aspects, UE PHY 6072 and peer entity gNB PHY 6090 may communicate using signals transmitted and received via a wireless medium. According to some aspects, UE MAC 6070 and peer entity gNB MAC 6088 may communicate using the services provided respectively by UE PHY 872 and gNB PHY 6090. According to some aspects, UE RLC 6068 and peer entity gNB RLC 6086 may communicate using the services provided respectively by UE MAC 6070 and gNB MAC 6088. According to some aspects, UE PDCP 6066 and peer entity gNB PDCP 6084 may communicate using the services provided respectively by UE RLC 6068 and 5GNB RLC 6086. According to some aspects, UE RRC 6064 and gNB RRC 6082 may communicate using the services provided respectively by UE PDCP 6066 and gNB PDCP 6084. According to some aspects, UE NAS 6062 and AMF NAS 6092 may communicate using the services provided respectively by UE RRC 6064 and gNB RRC 6082.

The PHY layer 6072 and 6090 may transmit or receive information used by the MAC layer 6070 and 6068 over one or more air interfaces. The PHY layer 6072 and 6090 may further perform link adaptation or adaptive modulation and coding (AMC), power control, cell search (e.g., for initial synchronization and handover purposes), and other measurements used by higher layers, such as the RRC layer 6064 and 6082. The PHY layer 6072 and 6090 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 6070 and 6088 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 6068 and 6086 may operate in a plurality of modes of operation, including: Transparent Mode (TM), Unacknowledged Mode (UM), and Acknowledged Mode (AM). The RLC layer 6068 and 6086 may execute transfer of upper layer protocol data units (PDUs), error correction through automatic repeat request (ARQ) for AM data transfers, and concatenation, segmentation and reassembly of RLC SDUs for UM and AM data transfers. The RLC layer 6068 and 6086 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 6066 and 6084 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 6064 and 6082 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 6060 and the RAN node, gNB 6080 may utilize a Uu interface (e.g., an LTE-Uu interface) to exchange control plane data via a protocol stack comprising the PHY layer 6072 and 6090, the MAC layer 6070 and 6088, the RLC layer 6068 and 6086, the PDCP layer 6066 and 6084, and the RRC layer 6064 and 6082.

The non-access stratum (NAS) protocols 6092 form the highest stratum of the control plane between the UE 6060 and the AMF 6005. The NAS protocols 6092 support the mobility of the UE 6060 and the session management procedures to establish and maintain IP connectivity between the UE 6060 and the Packet Data Network (PDN) Gateway (P-GW).

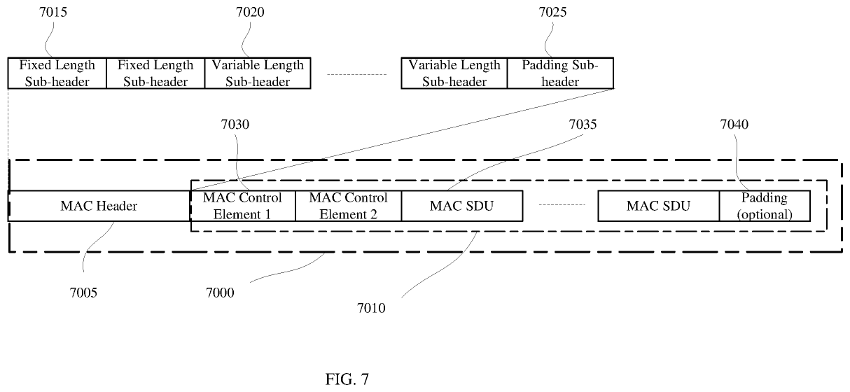

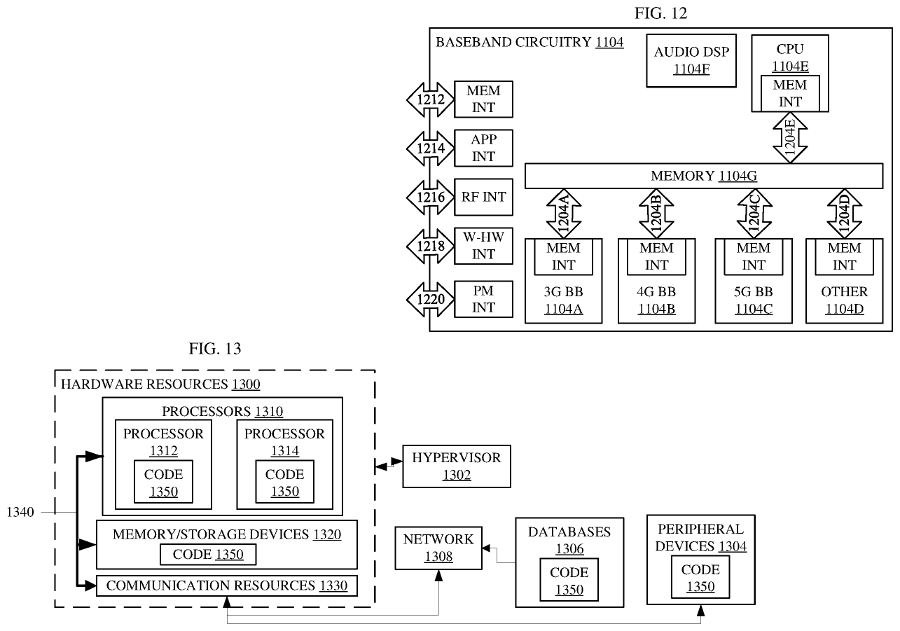

FIG. 7 illustrates embodiments of the formats of PHY data units (PDUs) that may be transmitted by the PHY device via one or more antennas and be encoded and decoded by a MAC entity such as the processors 203 and 213 in FIG. 2, and the baseband module 1104 in FIGS. 11 and 12 according to some aspects. In several embodiments, higher layer frames such as a frame comprising an RRC layer information element may transmit from the base station to the UE or vice versa as one or more MAC Service Data Units (MSDUs) in a payload of one or more PDUs in one or more subframes of a radio frame.

According to some aspects, a MAC PDU 7000 may consist of a MAC header 7005 and a MAC payload 7010, the MAC payload consisting of zero or more MAC control elements 7030, zero or more MAC service data unit (SDU) portions 7035 and zero or one padding portion 7040. According to some aspects, MAC header 7005 may consist of one or more MAC sub-headers, each of which may correspond to a MAC payload portion and appear in corresponding order. According to some aspects, each of the zero or more MAC control elements 7030 contained in MAC payload 7010 may correspond to a fixed length sub-header 7015 contained in MAC header 7005. According to some aspects, each of the zero or more MAC SDU portions 7035 contained in MAC payload 7010 may correspond to a variable length sub-header 7020 contained in MAC header 7005. According to some aspects, padding portion 7040 contained in MAC payload 7010 may correspond to a padding sub-header 7025 contained in MAC header 7005.

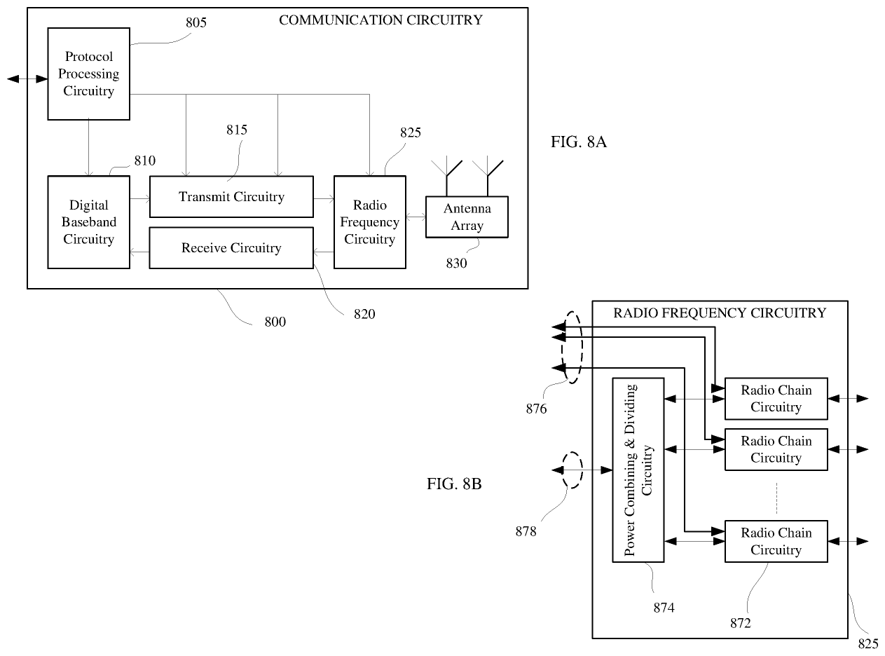

FIG. 8A illustrates an embodiment of communication circuitry 800 such as the circuitry in the base station 201 and the user equipment 211 shown in FIG. 2. The communication circuitry 800 is alternatively grouped according to functions. Components as shown in the communication circuitry 800 are shown here for illustrative purposes and may include other components not shown here in FIG. 8A.

The communication circuitry 800 may include protocol processing circuitry 805, which may implement one or more of medium access control (MAC), radio link control (RLC), packet data convergence protocol (PDCP), radio resource control (RRC) and non-access stratum (NAS) functions. The protocol processing circuitry 805 may include one or more processing cores (not shown) to execute instructions and one or more memory structures (not shown) to store program and data information.

The communication circuitry 800 may further include digital baseband circuitry 810, which may implement physical layer (PHY) functions including one or more of hybrid automatic repeat request (HARQ) functions, scrambling and/or descrambling, coding and/or decoding, layer mapping and/or de-mapping, modulation symbol mapping, received symbol and/or bit metric determination, multi-antenna port pre-coding and/or decoding which may include one or more of space-time, space-frequency or spatial coding, reference signal generation and/or detection, preamble sequence generation and/or decoding, synchronization sequence generation and/or detection, control channel signal blind decoding, and other related functions.

The communication circuitry 800 may further include transmit circuitry 815, receive circuitry 820 and/or antenna array circuitry 830.

The communication circuitry 800 may further include radio frequency (RF) circuitry 825. In an aspect of an embodiment, RF circuitry 825 may include multiple parallel RF chains for one or more of transmit or receive functions, each connected to one or more antennas of the antenna array 830.

In an aspect of the disclosure, the protocol processing circuitry 805 may include one or more instances of control circuitry (not shown) to provide control functions for one or more of digital baseband circuitry 810, transmit circuitry 815, receive circuitry 820, and/or radio frequency circuitry 825.

FIG. 8B illustrates an exemplary radio frequency circuitry 825 in FIG. 8A according to some aspects. The radio frequency circuitry 825 may include one or more instances of radio chain circuitry 872, which in some aspects may include one or more filters, power amplifiers, low noise amplifiers, programmable phase shifters and power supplies (not shown).

The radio frequency circuitry 825 may include power combining and dividing circuitry 874. In some aspects, power combining and dividing circuitry 874 may operate bidirectionally, such that the same physical circuitry may be configured to operate as a power divider when the device is transmitting, and as a power combiner when the device is receiving. In some aspects, power combining and dividing circuitry 874 may one or more include wholly or partially separate circuitries to perform power dividing when the device is transmitting and power combining when the device is receiving. In some aspects, power combining and dividing circuitry 874 may include passive circuitry comprising one or more two-way power divider/combiners arranged in a tree. In some aspects, power combining and dividing circuitry 874 may include active circuitry comprising amplifier circuits.

In some aspects, the radio frequency circuitry 825 may connect to transmit circuitry 815 and receive circuitry 820 in FIG. 8A via one or more radio chain interfaces 876 or a combined radio chain interface 878. The combined radio chain interface 878 may form a wide or very wide bandwidth.

In some aspects, one or more radio chain interfaces 876 may provide one or more interfaces to one or more receive or transmit signals, each associated with a single antenna structure which may comprise one or more antennas.

In some aspects, the combined radio chain interface 878 may provide a single interface to one or more receive or transmit signals, each associated with a group of antenna structures comprising one or more antennas.

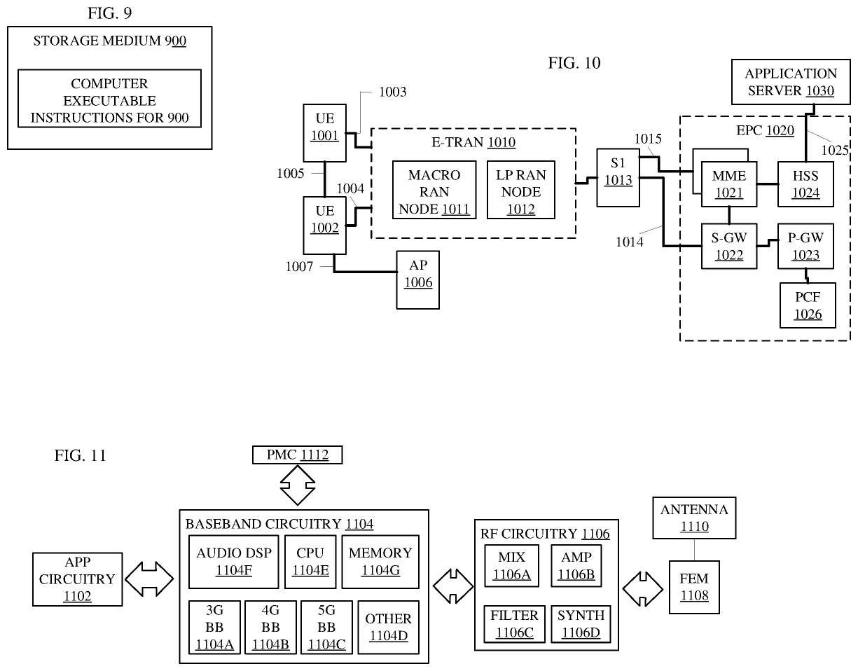

FIG. 9 illustrates an example of a storage medium 900 such as the storage medium in FIG. 3. Storage medium 900 may comprise an article of manufacture. In some examples, storage medium 900 may include any non-transitory computer readable medium or machine-readable medium, such as an optical, magnetic or semiconductor storage. Storage medium 900 may store diverse types of computer executable instructions, such as instructions to implement logic flows and/or techniques described herein. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like.

FIG. 10 illustrates an architecture of a system 1000 of a network in accordance with some embodiments. The system 1000 is shown to include a user equipment (UE) 1001 and a UE 1002 such as the UEs and AV-UEs discussed in conjunction with FIGS. 1-5B. The UEs 1001 and 1002 are part of aerial vehicles such as a cellular communications module that is integrated with an aerial vehicle like a drone and a smart phone (e.g., handheld touch screen mobile computing devices connectable to one or more cellular networks) mounted in an aerial vehicle, but may also comprise any mobile or non-mobile computing device, such as Personal Data Assistants (PDAs), pagers, laptop computers, desktop computers, wireless handsets, or any computing device including a wireless communications interface that is mounted in an aerial vehicle.

The UEs 1001 and 1002 may to connect, e.g., communicatively couple, with a radio access network (RAN)—in this embodiment, an Evolved Universal Mobile Telecommunications System (UMTS) Terrestrial Radio Access Network (E-UTRAN) 1010. The UEs 1001 and 1002 utilize connections 1003 and 1004, respectively, each of which comprises a physical communications interface or layer (discussed in further detail below); in this example, the connections 1003 and 1004 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 1001 and 1002 may further directly exchange communication data via a ProSe interface 1005. The ProSe interface 1005 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1002 is shown to be configured to access an access point (AP) 1006 via connection 1007. The connection 1007 can comprise a local wireless connection, such as a connection consistent with any IEEE 802.11 protocol, wherein the AP 1006 would comprise a wireless fidelity (WiFi®) router. In this example, the AP 1006 is shown to be connected to the Internet without connecting to the core network of the wireless system (described in further detail below). The E-UTRAN 1010 can include one or more access nodes that enable the connections 1003 and 1004. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The E-UTRAN 1010 may include one or more RAN nodes for providing macro-cells, e.g., macro RAN node 1011, and one or more RAN nodes for providing femto-cells or picocells (e.g., cells having smaller coverage areas, smaller user capacity, or higher bandwidth compared to macro-cells), e.g., low power (LP) RAN node 1012.

Any of the RAN nodes 1011 and 1012 can terminate the air interface protocol and can be the first point of contact for the UEs 1001 and 1002. In some embodiments, any of the RAN nodes 1011 and 1012 can fulfill various logical functions for the E-UTRAN 1010 including, but not limited to, radio network controller (RNC) functions such as radio bearer management, uplink and downlink dynamic radio resource management and data packet scheduling, and mobility management.

In accordance with some embodiments, the UEs 1001 and 1002 can be configured to communicate using Orthogonal Frequency-Division Multiplexing (OFDM) communication signals with each other or with any of the RAN nodes 1011 and 1012 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 1011 and 1012 to the UEs 1001 and 1002, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs 1001 and 1002. The physical downlink control channel (PDCCH) may carry information about the transport format and resource allocations related to the PDSCH channel, among other things. It may also inform the UEs 1001 and 1002 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the RAN nodes 1011 and 1012 based on channel quality information fed back from any of the UEs 1001 and 1002. The downlink resource assignment information may be sent on the PDCCH used for (e.g., assigned to) each of the UEs 1001 and 1002.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN nodes 1011 and 1012 may communicate with one another and/or with other access nodes in the E-UTRAN 1010 and/or in another RAN via an X2 interface, which is a signaling interface for communicating data packets between ANs. Some other suitable interface for communicating data packets directly between ANs may be used.

The E-UTRAN 1010 is shown to be communicatively coupled to a core network—in this embodiment, an Evolved Packet Core (EPC) network 1020 via an SI interface 1013. In this embodiment the SI interface 1013 is split into two parts: the S1-U interface 1014, which carries traffic data between the RAN nodes 1011 and 1012 and the serving gateway (S-GW) 1022, and the SI-mobility management entity (MME) interface 1015, which is a signaling interface between the RAN nodes 1011 and 1012 and MMEs 1021.

In this embodiment, the EPC network 1020 comprises the MMEs 1021, the S-GW 1022, the Packet Data Network (PDN) Gateway (P-GW) 1023, and a home subscriber server (HSS) 1024. The MMEs 1021 may be similar in function to the control plane of legacy Serving General Packet Radio Service (GPRS) Support Nodes (SGSN). The MMEs 1021 may manage mobility aspects in access such as gateway selection and tracking area list management. The HSS 1024 may comprise a database for network users, including subscription-related information to support the network entities' handling of communication sessions. The EPC network 1020 may comprise one or several HSSs 1024, depending on the number of mobile subscribers, on the capacity of the equipment, on the organization of the network, etc. For example, the HSS 1024 can provide support for routing/roaming, authentication, authorization, naming/addressing resolution, location dependencies, etc.

The S-GW 1022 may terminate the SI interface 1013 towards the E-UTRAN 1010, and routes data packets between the E-UTRAN 1010 and the EPC network 1020. In addition, the SGW 1022 may be a local mobility anchor point for inter-RAN node handovers and also may provide an anchor for inter-3GPP mobility. Other responsibilities may include lawful intercept, charging, and some policy enforcement.

The P-GW 1023 may terminate an SGi interface toward a PDN. The P-GW 1023 may route data packets between the EPC network 1023 and external networks such as a network including the application server 1030 (alternatively referred to as application function (AF)) via an Internet Protocol (IP) interface 1025. Generally, the application server 1030 may be an element offering applications that use IP bearer resources with the core network (e.g., UMTS Packet Services (PS) domain, LTE PS data services, etc.). In this embodiment, the P-GW 1023 is shown to be communicatively coupled to an application server 1030 via an IP communications interface 1025. The application server 1030 can also be configured to support one or more communication services (e.g., Voice-over-Internet Protocol (VoIP) sessions, PTT sessions, group communication sessions, social networking services, etc.) for the UEs 1001 and 1002 via the EPC network 1020.

The P-GW 1023 may further be a node for policy enforcement and charging data collection. Policy and Charging Enforcement Function (PCRF) 1026 is the policy and charging control element of the EPC network 1020. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1026 may be communicatively coupled to the application server 1030 via the P-GW 1023. The application server 1030 may signal the PCRF 1026 to indicate a new service flow and select the appropriate Quality of Service (QoS) and charging parameters. The PCRF 1026 may provision this rule into a Policy and Charging Enforcement Function (PCEF) (not shown) with the appropriate traffic flow template (TFT) and QoS class of identifier (QCI), which commences the QoS and charging as specified by the application server 1030.

FIG. 11 illustrates example components of a device 1100 in accordance with some embodiments. In some embodiments, the device 1100 may include application circuitry 1102, baseband circuitry 1104, Radio Frequency (RF) circuitry 1106, front-end module (FEM) circuitry 1108, one or more antennas 1110, and power management circuitry (PMC) 1112 coupled together at least as shown. The components of the illustrated device 1100 may be included in a UE or a RAN node such as the AV-UEs and base stations discussed in conjunction with FIGS. 1-5B. In some embodiments, the device 1100 may include less elements (e.g., a RAN node may not utilize application circuitry 1102, and instead include a processor/controller to process IP data received from an EPC). In some embodiments, the device 1100 may include additional elements such as, for example, memory/storage, display, camera, sensor, or input/output (I/0) interface. In other embodiments, the components described below may be included in more than one device (e.g., said circuitries may be separately included in more than one device for Cloud-RAN (C-RAN) implementations).

The application circuitry 1102 may include one or more application processors. For example, the application circuitry 1102 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1100. In some embodiments, processors of application circuitry 1102 may process IP data packets received from an EPC.

The baseband circuitry 1104 may include circuitry such as, but not limited to, one or more single-core or multi-core processors. The baseband circuitry 1104 may include one or more baseband processors or control logic to process baseband signals received from a receive signal path of the RF circuitry 1106 and to generate baseband signals for a transmit signal path of the RF circuitry 1106. Baseband processing circuitry 1104 may interface with the application circuitry 1102 for generation and processing of the baseband signals and for controlling operations of the RF circuitry 1106. For example, in some embodiments, the baseband circuitry 1104 may include a third generation (3G) baseband processor 1104A, a fourth generation (4G) baseband processor 1104B, a fifth generation (5G) baseband processor 1104C, or other baseband processor(s) 1104D for other existing generations, generations in development or to be developed in the future (e.g., second generation (2G), sixth generation (6G), etc.). The baseband circuitry 1104 (e.g., one or more of baseband processors 1104A-D) may handle various radio control functions that enable communication with one or more radio networks via the RF circuitry 1106. In other embodiments, some of or all the functionality of baseband processors 1104A-D may be included in modules stored in the memory 1104G and executed via a Central Processing Unit (CPU) 1104E. The radio control functions may include, but are not limited to, signal modulation/demodulation, encoding/decoding, radio frequency shifting, etc.

In some embodiments, modulation/demodulation circuitry of the baseband circuitry 1104 may include Fast-Fourier Transform (FFT), precoding, or constellation mapping/demapping functionality. In some embodiments, encoding/decoding circuitry of the baseband circuitry 1104 may include convolution, tail-biting convolution, turbo, Viterbi, or Low-Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1104 may include one or more audio digital signal processor(s) (DSP) 1104F. The audio DSP(s) 1104F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some of or all the constituent components of the baseband circuitry 1104 and the application circuitry 1102 may be implemented together such as, for example, on a system on a chip (SOC). In some embodiments, the baseband circuitry 1104 may provide for communication compatible with one or more radio technologies. For example, in some embodiments, the baseband circuitry 1104 may support communication with an evolved universal terrestrial radio access network (E-UTRAN) or other wireless metropolitan area networks (WMAN), a wireless local area network (WLAN), a wireless personal area network (WPAN). Embodiments in which the baseband circuitry 1104 is configured to support radio communications of more than one wireless protocol may be referred to as multi-mode baseband circuitry.

The RF circuitry 1106 may enable communication with wireless networks using modulated electromagnetic radiation through a non-solid medium. In various embodiments, the RF circuitry 1106 may include switches, filters, amplifiers, etc. to facilitate the communication with the wireless network. The RF circuitry 1106 may include a receive signal path which may include circuitry to down-convert RF signals received from the FEM circuitry 1108 and provide baseband signals to the baseband circuitry 1104. The RF circuitry 1106 may also include a transmit signal path which may include circuitry to up-convert baseband signals provided by the baseband circuitry 1104 and provide RF output signals to the FEM circuitry 1108 for transmission.

In some embodiments, the receive signal path of the RF circuitry 1106 may include mixer circuitry 1106a, amplifier circuitry 1106b and filter circuitry 1106c. In some embodiments, the transmit signal path of the RF circuitry 1106 may include filter circuitry 1106c and mixer circuitry 1106a. The RF circuitry 1106 may also include synthesizer circuitry 1106d for synthesizing a frequency, or component carrier, for use by the mixer circuitry 1106a of the receive signal path and the transmit signal path. In some embodiments, the mixer circuitry 1106a of the receive signal path may to down-convert RF signals received from the FEM circuitry 1108 based on the synthesized frequency provided by synthesizer circuitry 1106d. The amplifier circuitry 1106b may amplify the down-converted signals and the filter circuitry 1106c may be a low-pass filter (LPF) or band-pass filter (BPF) to remove unwanted signals from the down-converted signals to generate output baseband signals. Output baseband signals may be provided to the baseband circuitry 1104 for further processing.

In some embodiments, the output baseband signals may be zero-frequency baseband signals, although this is not a requirement. In some embodiments, mixer circuitry 1106a of the receive signal path may comprise passive mixers, although the scope of the embodiments is not limited in this respect.

In some embodiments, the mixer circuitry 1106a of the transmit signal path may be configured to up-convert input baseband signals based on the synthesized frequency provided by the synthesizer circuitry 1106d to generate RF output signals for the FEM circuitry 1108. The baseband signals may be provided by the baseband circuitry 1104 and may be filtered by filter circuitry 1106c.

In some embodiments, the mixer circuitry 1106a of the receive signal path and the mixer circuitry 1106a of the transmit signal path may include two or more mixers and may be arranged for quadrature downconversion and upconversion, respectively. In some embodiments, the mixer circuitry 1106a of the receive signal path and the mixer circuitry 1106a of the transmit signal path may include two or more mixers and may be arranged for image rejection (e.g., Hartley image rejection). In some embodiments, the mixer circuitry 1106a of the receive signal path and the mixer circuitry 1106a may be arranged for direct downconversion and direct upconversion, respectively. In some embodiments, the mixer circuitry 1106a of the receive signal path and the mixer circuitry 1106a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1106 may include analog-to-digital converter (ADC) and digital-to-analog converter (DAC) circuitry and the baseband circuitry 1104 may include a digital baseband interface to communicate with the RF circuitry 1106.

In some dual-mode embodiments, a separate radio IC circuitry may be provided for processing signals for each spectrum, although the scope of the embodiments is not limited in this respect.

In some embodiments, the synthesizer circuitry 1106d may be a fractional-N synthesizer or a fractional NIN+ I synthesizer, although the scope of the embodiments is not limited in this respect as other types of frequency synthesizers may be suitable. For example, synthesizer circuitry 1106d may be a delta-sigma synthesizer, a frequency multiplier, or a synthesizer comprising a phase-locked loop with a frequency divider.

The synthesizer circuitry 1106d may synthesize an output frequency for use by the mixer circuitry 1106a of the RF circuitry 1106 based on a frequency input and a divider control input. In some embodiments, the synthesizer circuitry 1106d may be a fractional NIN+ I synthesizer.

In some embodiments, frequency input may be an output of a voltage controlled oscillator (VCO), although that is not a requirement. Divider control input may be an output of either the baseband circuitry 1104 or the applications processor 1102 depending on the desired output frequency. Some embodiments may determine a divider control input (e.g., N) from a look-up table based on a channel indicated by the applications processor 1102.

The synthesizer circuitry 1106d of the RF circuitry 1106 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 1106d may generate a carrier frequency (or component carrier) as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a local oscillator (LO) frequency (fLO). In some embodiments, the RF circuitry 1106 may include an IQ/polar converter.

The FEM circuitry 1108 may include a receive signal path which may include circuitry to operate on RF signals received from one or more antennas 1110, amplify the received signals and provide the amplified versions of the received signals to the RF circuitry 1106 for further processing. FEM circuitry 1108 may also include a transmit signal path which may include circuitry configured to amplify signals for transmission provided by the RF circuitry 1106 for transmission by one or more of the one or more antennas 1110. In various embodiments, the amplification through the transmit or receive signal paths may be done solely in the RF circuitry 1106, solely in the FEM 1108, or in both the RF circuitry 1106 and the FEM 1108.

In some embodiments, the FEM circuitry 1108 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 1106). The transmit signal path of the FEM circuitry 1108 may include a power amplifier (PA) to amplify input RF signals (e.g., provided by RF circuitry 1106), and one or more filters to generate RF signals for subsequent transmission (e.g., by one or more of the one or more antennas 1110).

In the present embodiment, the radio refers to a combination of the RF circuitry 110 and the FEM 1108. The radio refers to the portion of the circuitry that generates and transmits or receives and processes the radio signals. The RF circuitry 1106 includes a transmitter to generate the time domain radio signals with the data from the baseband signals and apply the radio signals to subcarriers of the carrier frequency that form the bandwidth of the channel. The PA in the FEM 1108 amplifies the tones for transmission and amplifies tones received from the one or more antennas 1110 via the LNA to increase the signal-to-noise ratio (SNR) for interpretation. In wireless communications, the FEM 1108 may also search for a detectable pattern that appears to be a wireless communication. Thereafter, a receiver in the RF circuitry 1106 converts the time domain radio signals to baseband signals via one or more functional modules such as the functional modules shown in the base station 201 and user equipment 211 illustrated in FIG. 2.

In some embodiments, the PMC 1112 may manage power provided to the baseband circuitry 1104. In particular, the PMC 1112 may control power-source selection, voltage scaling, battery charging, or DC-to-DC conversion. The PMC 1112 may often be included when the device 1100 is capable of being powered by a battery, for example, when the device is included in a UE. The PMC 1112 may increase the power conversion efficiency while providing desirable implementation size and heat dissipation characteristics.

While FIG. 11 shows the PMC 1112 coupled only with the baseband circuitry 1104, in other embodiments, the PMC 1112 may be additionally or alternatively coupled with, and perform similar power management operations for, other components such as, but not limited to, application circuitry 1102, RF circuitry 1106, or FEM 1108.

In some embodiments, the PMC 1112 may control, or otherwise be part of, various power saving mechanisms of the device 1100. For example, if the device 1100 is in an RRC_Connected state, where it is still connected to the RAN node as it expects to receive traffic shortly, then it may enter a state known as Discontinuous Reception Mode (DRX) after a period of inactivity. During this state, the device 1100 may power down for brief intervals of time and thus save power.

If there is no data traffic activity for an extended period of time, then the device 1100 may transition off to an RRC Idle state, where it disconnects from the network and does not perform operations such as channel quality feedback, handover, etc. The device 1100 goes into a very low power state and it performs paging where again it periodically wakes up to listen to the network and then powers down again. The device 1100 may not receive data in this state, in order to receive data, it must transition back to RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

The processors of the application circuitry 1102 and the processors of the baseband circuitry 1104 may be used to execute elements of one or more instances of a protocol stack. For example, processors of the baseband circuitry 1104, alone or in combination, may be used execute Layer 3, Layer 2, or Layer I functionality, while processors of the application circuitry 1104 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer. As referred to herein, Layer 2 may comprise a medium access control (MAC) layer, a radio link control (RLC) layer, and a packet data convergence protocol (PDCP) layer. As referred to herein, Layer 1 may comprise a physical (PHY) layer of a UE/RAN node.

FIG. 12 illustrates example interfaces of baseband circuitry in accordance with some embodiments. As discussed above, the baseband circuitry 1104 of FIG. 11 may comprise processors 1104A-1104E and a memory 1104G utilized by said processors. Each of the processors 1104A-1104E may include a memory interface, 1204A-1204E, respectively, to send/receive data to/from the memory 1104G.

The baseband circuitry 1104 may further include one or more interfaces to communicatively couple to other circuitries/devices, such as a memory interface 1212 (e.g., an interface to send/receive data to/from memory external to the baseband circuitry 1104), an application circuitry interface 1214 (e.g., an interface to send/receive data to/from the application circuitry 1102 of FIG. 11), an RF circuitry interface 1216 (e.g., an interface to send/receive data to/from RF circuitry 1106 of FIG. 11), a wireless hardware connectivity interface 1218 (e.g., an interface to send/receive data to/from Near Field Communication (NFC) components, Bluetooth® components (e.g., Bluetooth® Low Energy), Wi-Fi® components, and other communication components), and a power management interface 1220 (e.g., an interface to send/receive power or control signals to/from the PMC 1112.

FIG. 13 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 13 shows a diagrammatic representation of hardware resources 1300 including one or more processors (or processor cores) 1310, one or more memory/storage devices 1320, and one or more communication resources 1330, each of which may be communicatively coupled via a bus 1340. For embodiments where node virtualization (e.g., NFV) is utilized, a hypervisor 1302 may be executed to provide an execution environment for one or more network slices/sub-slices to utilize the hardware resources 1300.

The processors 1310 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1312 and a processor 1314.

The memory/storage devices 1320 may comprise a storage medium such as the storage medium discussed in conjunction with FIGS. 3 and 9. The memory/storage devices 1320 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

The communication resources 1330 may include interconnection or network interface components or other suitable devices to communicate with one or more peripheral devices 1304 or one or more databases 1306 via a network 1308. For example, the communication resources 1330 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1350 may comprise software, a program, an application, an applet, an app, or other executable code for causing at least any of the processors 1310 to perform any one or more of the methodologies discussed herein. The instructions 1350 may reside, completely or partially, within at least one of the processors 1310 (e.g., within the processor's cache memory), the memory/storage devices 1320, or any suitable combination thereof. Furthermore, any portion of the instructions 1350 may be transferred to the hardware resources 1300 from any combination of the peripheral devices 1304 or the databases 1306. Accordingly, the memory of processors 1310, the memory/storage devices 1320, the peripheral devices 1304, and the databases 1306 are examples of computer-readable and machine-readable media.

In embodiments, one or more elements of FIGS. 10, 11, 12, and/or 13 may be configured to perform one or more processes, techniques, or methods as described herein, or portions thereof. In embodiments, one or more elements of FIGS. 10, 11, 12, and/or 13 may be configured to perform one or more processes, techniques, or methods, or portions thereof, as described in the following examples.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Processing circuitry, logic circuitry, devices, and interfaces herein described may perform functions implemented in hardware and also implemented with code executed on one or more processors. Processing circuitry, or logic circuitry, refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chip set, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits or circuitry to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

Several embodiments have one or more potentially advantages effects. For instance, communicating capabilities information from a user device, the capabilities information to indicate that the user device is part of an aerial vehicle (AV-UE) advantageously improves interference control. Generating a frame comprising a measurement configuration, the measurement configuration to establish a trigger event based on a height measurement advantageously improves interference control. Transmitting a measurement configuration, the measurement configuration to establish a trigger event based on a height measurement, the measurement configuration to instruct the AV-UE to transmit, in response to detection of the trigger event, a measurement report to a base station advantageously improves interference control. Communicating, by the baseband processing circuitry, with the user device, capability information to indicate that one or more of the specialized aerial vehicle features are enabled advantageously improves interference control. Communicating, by the baseband processing circuitry, with the user device, capability information to indicate parameters for one or more specialized aerial vehicle features that are valid and that the AV-UE will use if the base station enables the one or more specialized aerial vehicle features advantageously improves interference control. Communicating with the user device, capability information to indicate one or more other base stations that include specialized features to support communications with the AV-UE advantageously improves interference control. Communicating, by the baseband processing circuitry, with the user device, a signal to enable or disable communications between the base station and the AV-UE via a radio resource control (RRC) layer message or a system information block, wherein the system information block is transmitted to the AV-UE, to a group of AV-UEs, or to all AV-UEs advantageously improves interference control. A measurement configuration specific for aerial vehicle application comprising both periodic and event trigger measurement events advantageously improves interference control. A measurement configuration specific for aerial vehicle application to trigger an aerial vehicle function other than generation of a measurement report advantageously improves interference control. An interference avoidance function such as an interference nulling function and an interference mitigation function advantageously improves interference control. A user equipment with a subscriber identity module (SIM) to enable an aerial vehicle features, wherein the SIM is a physical SIM or a Soft SIM advantageously improves regulation compliance for drone communications. A measurement of height, velocity, and interference from one or more cells and a measurement of a number of detected cells, the measurement configuration to include a threshold for the number of detected cells as a second trigger event, to instruct the AV-UE to transmit, in response to detection of the second trigger event, a measurement report to the base station advantageously interference control.

### EXAMPLES OF FURTHER EMBODIMENTS

The following examples pertain to further embodiments. Specifics in the examples may be used anywhere in one or more embodiments.

Example 1 is an apparatus to signal for aerial vehicles, comprising: processing circuitry to decode uplink data including capabilities information, the capabilities information to indicate that the user device is part of an aerial vehicle (AV-UE); and to generate a data unit comprising a measurement configuration, the measurement configuration to establish a trigger event based on a height measurement, the measurement configuration to instruct the AV-UE to transmit, in response to detection of the trigger event, a measurement report to a base station comprising interference information for downlink communications between the base station and the AV-UE; and an interface coupled with the processing circuitry to send the data unit to a physical layer. In Example 2, the apparatus of Examples 1, 209, 219, and 229, further comprising a processor, a memory coupled with the processor, a radio coupled with the physical layer device, and one or more antennas coupled with a radio of the physical layer device to communicate with the AV-UE. In Example 3, the apparatus of Examples 1, 209, 219, and 229, wherein the processing circuitry is configured to communicate with the AV-UE, capability information to indicate that the base station includes specialized aerial vehicle features to support communications with the AV-UE. In Example 4, the apparatus of Examples 1, 209, 219, and 229, wherein the processing circuitry is configured to communicate with the AV-UE, capability information to indicate that one or more of the specialized aerial vehicle features are enabled. In Example 5, the apparatus of Examples 1, 209, 219, and 229, wherein the processing circuitry is configured to communicate with the AV-UE, capability information to indicate parameters for one or more specialized aerial vehicle features that are valid and that the AV-UE will use if the base station enables the one or more specialized aerial vehicle features. In Example 6, the apparatus of Examples 1, 209, 219, and 229, wherein the processing circuitry is configured to communicate with the AV-UE, capability information to indicate one or more other base stations that include specialized features to support communications with the AV-UE. In Example 7, the apparatus of Examples 1, 209, 219, and 229, wherein the processing circuitry is configured to communicate with the AV-UE, a signal to enable or disable communications between the base station and the AV-UE via a radio resource control (RRC) layer message. In Example 8, the apparatus of Examples 1, 209, 219, and 229, wherein the processing circuitry is configured to communicate with the AV-UE, a signal to enable or disable communications between the base station and the AV-UE via a radio resource control (RRC) layer message or a system information block, wherein the system information block is transmitted to the AV-UE, to a group of AV-UEs, or to all AV-UEs. In Example 9, the apparatus of Examples 1, 209, 219, and 229, wherein the measurement configuration comprises a measurement configuration specific for aerial vehicle application comprising both periodic and event trigger measurement events. In Example 10, the apparatus of Examples 1, 209, 219, and 229, wherein the measurement configuration comprises a measurement configuration specific for aerial vehicle application to trigger an aerial vehicle function other than generation of a measurement report. In Example 11, the apparatus of Example 10, wherein the measurement configuration comprises one or more criteria for the aerial vehicle function. In Example 12, the apparatus of Example 10, wherein the aerial vehicle function comprises an interference avoidance function. In Example 13, the apparatus of Example 12, wherein an interference avoidance function comprises an interference nulling function. In Example 14, the apparatus of Example 12, wherein an interference avoidance function comprises an interference mitigation function. In Example 15, the apparatus of Examples 1, 209, 219, and 229, wherein the AV-UE comprises a user equipment with a subscriber identity module (SIM) to enable an aerial vehicle features, wherein the SIM is a physical SIM or a Soft SIM. In Example 16, the apparatus of Examples 1, 209, 219, and 229, wherein the measurement configuration comprises a measurement of height, velocity, and interference from one or more cells and a measurement of a number of detected cells, the measurement configuration to include a threshold for the number of detected cells as a second trigger event, to instruct the AV-UE to transmit, in response to detection of the second trigger event, a measurement report to the base station. In Example 17, the apparatus of Examples 1, 209, 219, and 229, wherein the measurement configuration comprises configuration of an uplink measurement for the AV-UE. In Example 18, the apparatus of Examples 1, 209, 219, and 229, wherein the processing circuitry is configured to communicate with the AV-UE, a map of a high-density area for communications to the AV-UE to enable an aerial vehicle function. In Example 19, the apparatus of Example 18, the map of the high-density area for communications comprise a map based trigger event to instruct the AV-UE to reduce power for transmissions from the AV-UE in response to entering an indicator area identified by the map. In Example 20, the apparatus of Example 17, wherein the processing circuitry is configured to communicate with the AV-UE, to indicate to the AV-UE to reduce transmission power. In Example 21, the apparatus of Examples 1, 209, 219, and 229, wherein the processing circuitry is configured to communicate with the AV-UE, to enable a specialized aerial vehicle feature, the specialized aerial vehicle feature to comprise interference nulling.

Example 22 is a method to signal for aerial vehicles, comprising: receiving, by the baseband processing circuitry, capabilities information from a user device, the capabilities information to indicate that the user device is part of an aerial vehicle (AV-UE); and generating, by the baseband processing circuitry, to send to a physical layer, a measurement configuration, the measurement configuration to establish a trigger event based on a height measurement, the measurement configuration to instruct the AV-UE to transmit, in response to detection of the trigger event, a measurement report to a base station comprising interference information for downlink communications between the base station and the AV-UE. In Example 23, the method of Examples 22, 210, 220, and 230, further comprising communicating, by the baseband processing circuitry, with the user device, capability information to indicate that the base station includes specialized aerial vehicle features to support communications with the AV-UE. In Example 24, the method of Examples 22, 210, 220, and 230, further comprising communicating, by the baseband processing circuitry, with the user device, capability information to indicate that one or more of the specialized aerial vehicle features are enabled. In Example 25, the method of Example 24, further comprising communicating, by the baseband processing circuitry, with the user device, capability information to indicate parameters for one or more specialized aerial vehicle features that are valid and that the AV-UE will use if the base station enables the one or more specialized aerial vehicle features. In Example 26, the method of Examples 22, 210, 220, and 230, further comprising communicating, by the baseband processing circuitry, with the user device, capability information to indicate one or more other base stations that include specialized features to support communications with the AV-UE. In Example 27, the method of Examples 22, 210, 220, and 230, further comprising communicating, by the baseband processing circuitry, with the user device, a signal to enable or disable communications between the base station and the AV-UE via a radio resource control (RRC) layer message. In Example 28, the method of Examples 22, 210, 220, and 230, further comprising communicating, by the baseband processing circuitry, with the user device, a signal to enable or disable communications between the base station and the AV-UE via a radio resource control (RRC) layer message or a system information block, wherein the system information block is transmitted to the AV-UE, to a group of AV-UEs, or to all AV-UEs. In Example 29, the method of Examples 22, 210, 220, and 230, wherein the measurement configuration comprises a measurement configuration specific for aerial vehicle application comprising both periodic and event trigger measurement events. In Example 30, the method of Examples 22, 210, 220, and 230, wherein the measurement configuration comprises a measurement configuration specific for aerial vehicle application to trigger an aerial vehicle function other than generation of a measurement report. In Example 31, the method of Example 30, wherein the measurement configuration comprises one or more criteria for the aerial vehicle function. In Example 32, the method of Example 30, wherein the aerial vehicle function comprises an interference avoidance function. In Example 33, the method of Example 32, wherein an interference avoidance function comprises an interference nulling function. In Example 34, the method of Example 32, wherein an interference avoidance function comprises an interference mitigation function. In Example 35, the method of Examples 22, 210, 220, and 230, wherein the AV-UE comprises a user equipment with a subscriber identity module (SIM) to enable an aerial vehicle features, wherein the SIM is a physical SIM or a Soft SIM. In Example 36, the method of Examples 22, 210, 220, and 230, wherein the measurement configuration comprises a measurement of height, velocity, and interference from one or more cells and a measurement of a number of detected cells, the measurement configuration to include a threshold for the number of detected cells as a second trigger event, to instruct the AV-UE to transmit, in response to detection of the second trigger event, a measurement report to the base station. In Example 37, the method of Examples 22, 210, 220, and 230, wherein the measurement configuration comprises configuration of an uplink measurement for the AV-UE. In Example 38, the method of Examples 22, 210, 220, and 230, further comprising transmitting, by the base station, a map of a high-density area for communications to the AV-UE to enable an aerial vehicle function. In Example 39, the method of Example 38, wherein transmitting, by the base station, the map of the high-density area for communications to the AV-UE to enable an aerial vehicle function comprises instructing with a map based trigger event, the AV-UE to reduce power for transmissions from the AV-UE in response to entering an indicator area identified by the map. In Example 42, the method of Examples 22, 210, 220, and 230, further comprising communicating, by the baseband processing circuitry, with the AV-UE, to indicate to the AV-UE to reduce transmission power. In Example 41, the method of Examples 22, 210, 220, and 230, further comprising communicating, by the baseband processing circuitry, with the AV-UE, to enable a specialized aerial vehicle feature, the specialized aerial vehicle feature to comprise interference nulling.

Example 42, a system to signal for aerial vehicles, comprising: one or more antennas;

processing circuitry to decode uplink data including capabilities information, the capabilities information to indicate that the user device is part of an aerial vehicle (AV-UE); and to generate a data unit comprising a measurement configuration, the measurement configuration to establish a trigger event based on a height measurement, the measurement configuration to instruct the AV-UE to transmit, in response to detection of the trigger event, a measurement report to a base station comprising interference information for downlink communications between the base station and the AV-UE; and a physical layer device coupled with the processing circuitry and the one or more antennas to transmit the frame with a preamble. In Example 43, the system of Examples 42, 215, 225, and 235, wherein the processing circuitry comprises a processor, and a memory coupled with the processor, and the physical layer device comprises a radio coupled with the one or more antennas to communicate with the AV-UE. In Example 44, the system of Examples 42, 215, 225, and 235, wherein the processing circuitry is configured to communicate with the AV-UE, capability information to indicate that the base station includes specialized aerial vehicle features to support communications with the AV-UE. In Example 45, the system of Examples 42, 215, 225, and 235, wherein the processing circuitry is configured to communicate with the AV-UE, capability information to indicate that one or more of the specialized aerial vehicle features are enabled. In Example 46, the system of Examples 42, 215, 225, and 235, wherein the processing circuitry is configured to communicate with the AV-UE, capability information to indicate parameters for one or more specialized aerial vehicle features that are valid and that the AV-UE will use if the base station enables the one or more specialized aerial vehicle features. In Example 47, the system of Examples 42, 215, 225, and 235, wherein the processing circuitry is configured to communicate with the AV-UE, capability information to indicate one or more other base stations that include specialized features to support communications with the AV-UE. In Example 48, the system of Examples 42, 215, 225, and 235, wherein the processing circuitry is configured to communicate with the AV-UE, a signal to enable or disable communications between the base station and the AV-UE via a radio resource control (RRC) layer message. In Example 49. The system of Examples 42, 215, 225, and 235, wherein the processing circuitry is configured to communicate with the AV-UE, a signal to enable or disable communications between the base station and the AV-UE via a radio resource control (RRC) layer message or a system information block, wherein the system information block is transmitted to the AV-UE, to a group of AV-UEs, or to all AV-UEs. In Example 50, the system of Examples 42, 215, 225, and 235, wherein the measurement configuration comprises a measurement configuration specific for aerial vehicle application comprising both periodic and event trigger measurement events. In Example 51, the system of Examples 42, 215, 225, and 235, wherein the measurement configuration comprises a measurement configuration specific for aerial vehicle application to trigger an aerial vehicle function other than generation of a measurement report. In Example 52, the system of Example 51, wherein the measurement configuration comprises one or more criteria for the aerial vehicle function. In Example 53, the system of Example 51, wherein the aerial vehicle function comprises an interference avoidance function. In Example 54, the system of Example 53, wherein an interference avoidance function comprises an interference nulling function. In Example 55, the system of Example 53, wherein an interference avoidance function comprises an interference mitigation function. In Example 56, the system of Examples 42, 215, 225, and 235, wherein the AV-UE comprises a user equipment with a subscriber identity module (SIM) to enable an aerial vehicle features, wherein the SIM is a physical SIM or a Soft SIM. In Example 57. The system of Examples 42, 215, 225, and 235, wherein the measurement configuration comprises a measurement of height, velocity, and interference from one or more cells and a measurement of a number of detected cells, the measurement configuration to include a threshold for the number of detected cells as a second trigger event, to instruct the AV-UE to transmit, in response to detection of the second trigger event, a measurement report to the base station. In Example 58, the system of Examples 42, 215, 225, and 235, wherein the measurement configuration comprises configuration of an uplink measurement for the AV-UE. In Example 59, the system of Examples 42, 215, 225, and 235, wherein the processing circuitry is configured to communicate with the AV-UE, a map of a high-density area for communications to the AV-UE to enable an aerial vehicle function. In Example 60, the system of Example 59, the map of the high-density area for communications comprise a map based trigger event to instruct the AV-UE to reduce power for transmissions from the AV-UE in response to entering an indicator area identified by the map. In Example 61, the system of Example 59, wherein the processing circuitry is configured to communicate with the AV-UE, to indicate to the AV-UE to reduce transmission power. In Example 62, the system of Examples 42, 215, 225, and 235, wherein the processing circuitry is configured to communicate with the AV-UE, to enable a specialized aerial vehicle feature, the specialized aerial vehicle feature to comprise interference nulling.

Example 63, a machine-readable medium containing instructions, which when executed by a processor, cause the processor to perform operations, the operations comprising: receiving, by the baseband processing circuitry, capabilities information from a user device, the capabilities information to indicate that the user device is part of an aerial vehicle (AV-UE); and generating, by the baseband processing circuitry, to send to a physical layer, a measurement configuration, the measurement configuration to establish a trigger event based on a height measurement, the measurement configuration to instruct the AV-UE to transmit, in response to detection of the trigger event, a measurement report to a base station comprising interference information for downlink communications between the base station and the AV-UE. In Example 64, the machine-readable medium of Examples 63, 211, 221, and 231, wherein the operations further comprise communicating, by the baseband processing circuitry, with the user device, capability information to indicate that the base station includes specialized aerial vehicle features to support communications with the AV-UE. In Example 65, the machine-readable medium of Examples 63, 211, 221, and 231, wherein the operations further comprise communicating, by the baseband processing circuitry, with the user device, capability information to indicate that one or more of the specialized aerial vehicle features are enabled. In Example 66, the machine-readable medium of Examples 63, 211, 221, and 231, wherein the operations further comprise communicating, by the baseband processing circuitry, with the user device, capability information to indicate parameters for one or more specialized aerial vehicle features that are valid and that the AV-UE will use if the base station enables the one or more specialized aerial vehicle features. In Example 67, the machine-readable medium of Examples 63, 211, 221, and 231, wherein the operations further comprise communicating, by the baseband processing circuitry, with the user device, capability information to indicate one or more other base stations that include specialized features to support communications with the AV-UE. In Example 68, the machine-readable medium of Examples 63, 211, 221, and 231, wherein the operations further comprise communicating, by the baseband processing circuitry, with the user device, a signal to enable or disable communications between the base station and the AV-UE via a radio resource control (RRC) layer message. In Example 69, the machine-readable medium of Examples 63, 211, 221, and 231, wherein the operations further comprise communicating, by the baseband processing circuitry, with the user device, a signal to enable or disable communications between the base station and the AV-UE via a radio resource control (RRC) layer message or a system information block, wherein the system information block is transmitted to the AV-UE, to a group of AV-UEs, or to all AV-UEs. In Example 70, the machine-readable medium of Examples 63, 211, 221, and 231, wherein the measurement configuration comprises a measurement configuration specific for aerial vehicle application comprising both periodic and event trigger measurement events. In Example 71, the machine-readable medium of Examples 63, 211, 221, and 231, wherein the measurement configuration comprises a measurement configuration specific for aerial vehicle application to trigger an aerial vehicle function other than generation of a measurement report. In Example 72, the machine-readable medium of Example 71, wherein the measurement configuration comprises one or more criteria for the aerial vehicle function. In Example 73, the machine-readable medium of Example 71, wherein the aerial vehicle function comprises an interference avoidance function. In Example 74, the machine-readable medium of Example 73, wherein an interference avoidance function comprises an interference nulling function. In Example 75, the machine-readable medium of Example 73, wherein an interference avoidance function comprises an interference mitigation function. In Example 76, the machine-readable medium of Examples 63, 211, 221, and 231, wherein the AV-UE comprises a user equipment with a subscriber identity module (SIM) to enable an aerial vehicle features, wherein the SIM is a physical SIM or a Soft SIM. In Example 77, the machine-readable medium of Examples 63, 211, 221, and 231, wherein the measurement configuration comprises a measurement of height, velocity, and interference from one or more cells and a measurement of a number of detected cells, the measurement configuration to include a threshold for the number of detected cells as a second trigger event, to instruct the AV-UE to transmit, in response to detection of the second trigger event, a measurement report to the base station. In Example 78, the machine-readable medium of Examples 63, 211, 221, and 231, wherein the measurement configuration comprises configuration of an uplink measurement for the AV-UE. In Example 79, the machine-readable medium of Examples 63, 211, 221, and 231, wherein the operations further comprise transmitting, by the base station, a map of a high-density area for communications to the AV-UE to enable an aerial vehicle function. In Example 80, the machine-readable medium of Examples 63, 211, 221, and 231, wherein transmitting, by the base station, the map of the high-density area for communications to the AV-UE to enable an aerial vehicle function comprises a map based trigger event to instruct the AV-UE to reduce power for transmissions from the AV-UE in response to entering an indicator area identified by the map. In Example 81, the machine-readable medium of Example 80, wherein the operations further comprise communicating, by the baseband processing circuitry, with the AV-UE, to indicate to the AV-UE to reduce transmission power. In Example 82, the machine-readable medium of Example 80, wherein the operations further comprise communicating, by the baseband processing circuitry, with the AV-UE, to enable a specialized aerial vehicle feature, the specialized aerial vehicle feature to comprise interference nulling.

### Example 83

A device to signal for aerial vehicles, comprising: a means for receiving capabilities information from a user device, the capabilities information to indicate that the user device is part of an aerial vehicle (AV-UE); and a means for generating, by the baseband processing circuitry, to send to a physical layer, a measurement configuration, the measurement configuration to establish a trigger event based on a height measurement, the measurement configuration to instruct the AV-UE to transmit, in response to detection of the trigger event, a measurement report to a base station comprising interference information for downlink communications between the base station and the AV-UE. In Example 84, the device of Examples 83, 216, 226, and 236, further comprising a means for communicating with the user device, capability information to indicate that the base station includes specialized aerial vehicle features to support communications with the AV-UE. In Example 85, the device of Examples 83, 216, 226, and 236, further comprising a means for communicating with the user device, capability information to indicate that one or more of the specialized aerial vehicle features are enabled. In Example 86, the device of Examples 83, 216, 226, and 236, further comprising a means for communicating with the user device, capability information to indicate parameters for one or more specialized aerial vehicle features that are valid and that the AV-UE will use if the base station enables the one or more specialized aerial vehicle features. In Example 87, the device of Examples 83, 216, 226, and 236, further comprising a means for communicating with the user device, capability information to indicate one or more other base stations that include specialized features to support communications with the AV-UE. In Example 88, the device of Examples 83, 216, 226, and 236, further comprising a means for communicating with the user device, a signal to enable or disable communications between the base station and the AV-UE via a radio resource control (RRC) layer message. In Example 89, the device of Examples 83, 216, 226, and 236, further comprising a means for communicating with the user device, a signal to enable or disable communications between the base station and the AV-UE via a radio resource control (RRC) layer message or a system information block, wherein the system information block is transmitted to the AV-UE, to a group of AV-UEs, or to all AV-UEs. In Example 90, the device of Examples 83, 216, 226, and 236, wherein the measurement configuration comprises a measurement configuration specific for aerial vehicle application comprising both periodic and event trigger measurement events. In Example 91, the device of Examples 83, 216, 226, and 236, wherein the measurement configuration comprises a measurement configuration specific for aerial vehicle application to trigger an aerial vehicle function other than generation of a measurement report. In Example 92, the device of Example 91, wherein the measurement configuration comprises one or more criteria for the aerial vehicle function. In Example 93, the device of Example 91, wherein the aerial vehicle function comprises an interference avoidance function. In Example 94, the device of Example 93, wherein an interference avoidance function comprises an interference nulling function. In Example 95, the device of Example 93, wherein an interference avoidance function comprises an interference mitigation function. In Example 96, the device of Examples 83, 216, 226, and 236, wherein the AV-UE comprises a user equipment with a subscriber identity module (SIM) to enable an aerial vehicle features, wherein the SIM is a physical SIM or a Soft SIM. In Example 97, the device of Examples 83, 216, 226, and 236, wherein the measurement configuration comprises a measurement of height, velocity, and interference from one or more cells and a measurement of a number of detected cells, the measurement configuration to include a threshold for the number of detected cells as a second trigger event, to instruct the AV-UE to transmit, in response to detection of the second trigger event, a measurement report to the base station. In Example 98, the device of Examples 83, 216, 226, and 236, wherein the measurement configuration comprises configuration of an uplink measurement for the AV-UE. In Example 99, the device of Examples 83, 216, 226, and 236, further comprising means for transmitting a map of a high-density area for communications to the AV-UE to enable an aerial vehicle function. In Example 100, the device of Example 99, wherein the means for transmitting the map of the high-density area for communications to the AV-UE to enable an aerial vehicle function comprises a means for instructing with a map based trigger event, the AV-UE to reduce power for transmissions from the AV-UE in response to entering an indicator area identified by the map. In Example 101, the device of Examples 83, 216, 226, and 236, further comprising a means for communicating with the AV-UE, to indicate to the AV-UE to reduce transmission power. In Example 102, the device of Examples 83, 216, 226, and 236, further comprising a means for communicating with the AV-UE, to enable a specialized aerial vehicle feature, the specialized aerial vehicle feature to comprise interference nulling. In Example 103 is an apparatus to signal for aerial vehicles, comprising: a physical layer device to encode capabilities information for a user device, the capabilities information to indicate that the user device is part of an aerial vehicle (AV-UE); and processing circuitry coupled with the physical layer to decode a measurement configuration, the measurement configuration to establish a trigger event based on a height measurement, the measurement configuration to instruct the AV-UE to transmit, in response to detection of the trigger event, a measurement report to a base station comprising interference information for downlink communications between the base station and the AV-UE. In Example 104, the apparatus of Examples 103, 212, 222, and 232, further comprising a processor, a memory coupled with the processor, a radio coupled with the physical layer device, and one or more antennas coupled with a radio of the physical layer device to communicate with the user device.

In Example 105, the apparatus of Examples 103, 212, 222, and 232, wherein the processing circuitry is configured to receive from the base station, capability information to indicate that the base station includes specialized aerial vehicle features to support communications with the AV-UE. In Example 106, the apparatus of Examples 103, 212, 222, and 232, wherein the processing circuitry is configured to receive from the base station, capability information to indicate that one or more of the specialized aerial vehicle features are enabled. In Example 107, the apparatus of Examples 103, 212, 222, and 232, wherein the processing circuitry is configured to receive from the base station, capability information to indicate parameters for one or more specialized aerial vehicle features that are valid and that the AV-UE will use if the base station enables the one or more specialized aerial vehicle features. In Example 108, the apparatus of Examples 103, 212, 222, and 232, wherein the processing circuitry is configured to receive from the base station, a capability information to indicate one or more other base stations that include specialized features to support communications with the AV-UE. In Example 109, the apparatus of Examples 103, 212, 222, and 232, wherein the processing circuitry is configured to communicate with the AV-UE, to indicate to the AV-UE to reduce transmission power. In Example 110, the apparatus of Examples 103, 212, 222, and 232, wherein the processing circuitry is configured to receive from the base station, a signal to enable or disable communications between the base station and the AV-UE via a radio resource control (RRC) layer message or a system information block, wherein the system information block is transmitted to the AV-UE, to a group of AV-UEs, or to all AV-UEs. In Example 111, the apparatus of Examples 103, 212, 222, and 232, wherein the measurement configuration comprises a measurement configuration specific for aerial vehicle application comprising both periodic and event trigger measurement events. In Example 112, the apparatus of Examples 103, 212, 222, and 232, wherein the measurement configuration comprises a measurement configuration specific for aerial vehicle application to trigger an aerial vehicle function other than generation of a measurement report. In Example 113, the apparatus of Example 112, wherein the measurement configuration comprises one or more criteria for the aerial vehicle function. In Example 114, the apparatus of Example 112, wherein the aerial vehicle function comprises an interference avoidance function. In Example 115, the apparatus of Example 114, wherein an interference avoidance function comprises an interference nulling function. In Example 116, the apparatus of Example 114, wherein an interference avoidance function comprises an interference mitigation function. In Example 117, the apparatus of Examples 103, 212, 222, and 232, wherein the AV-UE comprises a user equipment with a subscriber identity module (SIM) to enable an aerial vehicle features, wherein the SIM is a physical SIM or a Soft SIM. In Example 118, the apparatus of Examples 103, 212, 222, and 232, wherein the measurement configuration comprises a measurement of height, velocity, and interference from one or more cells and a measurement of a number of detected cells, the measurement configuration to include a threshold for the number of detected cells as a second trigger event, to instruct the AV-UE to transmit, in response to detection of the second trigger event, a measurement report to the base station. In Example 119, the apparatus of Examples 103, 212, 222, and 232, wherein the measurement configuration comprises configuration of an uplink measurement for the AV-UE. In Example 120, the apparatus of Examples 103, 212, 222, and 232, wherein the processing circuitry is configured to transmit, via the physical layer device, a map of a high-density area for communications to the AV-UE to enable an aerial vehicle function. In Example 121, the apparatus of Example 120, wherein transmission of the map of the high-density area for communications to the AV-UE to enable an aerial vehicle function comprises a map based trigger event to instruct the AV-UE to reduce power for transmissions from the AV-UE in response to entering an indicator area identified by the map. In Example 122, the apparatus of Examples 103, 212, 222, and 232, wherein the processing circuitry is configured to communicate with the AV-UE, to enable a specialized aerial vehicle feature, the specialized aerial vehicle feature to comprise interference nulling. In Example 123, the apparatus of Examples 103, 212, 222, and 232, wherein the processing circuitry is configured to perform at least one measurement of a configured measurement type of detected cells on all the layers of carrier frequencies, wherein the configured measurement types comprise at least Reference Signal Received Power (RSRP), Reference Signal Received Quality (RSRQ), Reference Signal-Signal to Noise and Interference Ratio (RS-SINR), New Radio Synchronization Signal-Reference Signal Received Power (NR SS-RSRP), New Radio Synchronization Signal-Reference Signal Received Quality (NR SS-RSRQ), and New Radio Synchronization Signal-Signal to Noise and Interference Ratio (NR SS-SINR).

Example 124 is a method to signal for aerial vehicles, comprising: encoding, by baseband processing circuitry, capabilities information for a user device, to transmit to a base station, the capabilities information to indicate that the user device is part of an aerial vehicle (AV-UE); and decoding, by the baseband processing circuitry, a measurement configuration from a physical layer, the measurement configuration to establish a trigger event based on a height measurement, the measurement configuration to instruct the AV-UE to transmit, in response to detection of the trigger event, a measurement report to the base station comprising interference information for downlink communications between the base station and the AV-UE. In Example 126, the method of Examples 124, 213, 223, and 233, further comprising receiving, by the baseband processing circuitry, from the base station, capability information to indicate that one or more of the specialized aerial vehicle features are enabled. In Example 127, the method of Examples 124, 213, 223, and 233, further comprising receiving, by the baseband processing circuitry, from the base station, capability information to indicate parameters for one or more specialized aerial vehicle features that are valid and that the AV-UE will use if the base station enables the one or more specialized aerial vehicle features. In Example 128, the method of Examples 124, 213, 223, and 233, further comprising receiving, by the baseband processing circuitry, from the base station, a capability information to indicate one or more other base stations that include specialized features to support communications with the AV-UE. In Example 129, the method of Examples 124, 213, 223, and 233, further comprising receiving, by the baseband processing circuitry, from the base station, a signal to enable or disable communications between the base station and the AV-UE via a radio resource control (RRC) layer message. In Example 130, the method of Examples 124, 213, 223, and 233, further comprising receiving, by the baseband processing circuitry, from the base station, a signal to enable or disable communications between the base station and the AV-UE via a radio resource control (RRC) layer message or a system information block, wherein the system information block is transmitted to the AV-UE, to a group of AV-UEs, or to all AV-UEs. In Example 131, the method of Examples 124, 213, 223, and 233, wherein the measurement configuration comprises a measurement configuration specific for aerial vehicle application comprising both periodic and event trigger measurement events. In Example 132, the method of Examples 124, 213, 223, and 233, wherein the measurement configuration comprises a measurement configuration specific for aerial vehicle application to trigger an aerial vehicle function other than generation of a measurement report. In Example 133, the method of Example 132, wherein the measurement configuration comprises one or more criteria for the aerial vehicle function. In Example 134, the method of Example 132, wherein the aerial vehicle function comprises an interference avoidance function. In Example 135, the method of Example 134, wherein an interference avoidance function comprises an interference nulling function. In Example 136, the method of Example 134, wherein an interference avoidance function comprises an interference mitigation function. In Example 137, the method of Examples 124, 213, 223, and 233, wherein the AV-UE comprises a user equipment with a subscriber identity module (SIM) to enable an aerial vehicle features, wherein the SIM is a physical SIM or a Soft SIM. In Example 138, the method of Examples 124, 213, 223, and 233, wherein the measurement configuration comprises a measurement of height, velocity, and interference from one or more cells and a measurement of a number of detected cells, the measurement configuration to include a threshold for the number of detected cells as a second trigger event, to instruct the AV-UE to transmit, in response to detection of the second trigger event, a measurement report to the base station. In Example 139, the method of Examples 124, 213, 223, and 233, wherein the measurement configuration comprises configuration of an uplink measurement for the AV-UE. In Example 140, the method of Examples 124, 213, 223, and 233, further comprising transmitting, by the base station via the physical layer device, a map of a high-density area for communications to the AV-UE to enable an aerial vehicle function. In Example 141, the method of Example 140, wherein transmitting, by the base station, the map of the high-density area for communications to the AV-UE to enable an aerial vehicle function comprises a map based trigger event to instruct the AV-UE to reduce power for transmissions from the AV-UE in response to entering an indicator area identified by the map. In Example 142, the method of Examples 124, 213, 223, and 233, further comprising communicating, by the baseband processing circuitry, with the AV-UE, to indicate to the AV-UE to reduce transmission power. In Example 143, the method of Examples 124, 213, 223, and 233, further comprising communicating, by the baseband processing circuitry, with the AV-UE, to enable a specialized aerial vehicle feature, the specialized aerial vehicle feature to comprise interference nulling. In Example 143, the method of Examples 124, 213, 223, and 233, wherein the measurement configuration is indicated by a radio resource control layer (RRC) message. In Example 144, the method of Examples 124, 213, 223, and 233, wherein the user device is capable of performing at least one measurement of a configured measurement type of detected cells on all the layers of carrier frequencies, wherein the configured measurement types comprise at least Reference Signal Received Power (RSRP), Reference Signal Received Quality (RSRQ), Reference Signal-Signal to Noise and Interference Ratio (RS-SINR), New Radio Synchronization Signal-Reference Signal Received Power (NR SS-RSRP), New Radio Synchronization Signal-Reference Signal Received Quality (NR SS-RSRQ), and New Radio Synchronization Signal-Signal to Noise and Interference Ratio (NR SS-SINR).

Example 145, a system to signal for aerial vehicles, comprising: one or more antennas;

a physical layer device coupled with the one or more antennas to transmit capabilities information from a user device, the capabilities information to indicate that the user device is part of an aerial vehicle (AV-UE); and processing circuitry coupled with the physical layer to decode a measurement configuration, the measurement configuration to establish a trigger event based on a height measurement, the measurement configuration to instruct the AV-UE to transmit, in response to detection of the trigger event, a measurement report to a base station comprising interference information for downlink communications between the base station and the AV-UE. In Example 146, the system of Examples 145, 217, 227, and 237, wherein the processing circuitry comprises a processor, and a memory coupled with the processor, and the physical layer device comprises a radio, and wherein the apparatus further comprises one or more antennas coupled with the radio to communicate with the user device. In Example 147, the system of Examples 145, 217, 227, and 237, wherein the processing circuitry is configured to receive from the base station, capability information to indicate that the base station includes specialized aerial vehicle features to support communications with the AV-UE. In Example 148, the system of Examples 145, 217, 227, and 237, wherein the processing circuitry is configured to receive from the base station, capability information to indicate that one or more of the specialized aerial vehicle features are enabled. In Example 149, the system of Examples 145, 217, 227, and 237, wherein the processing circuitry is configured to receive from the base station, capability information to indicate parameters for one or more specialized aerial vehicle features that are valid and that the AV-UE will use if the base station enables the one or more specialized aerial vehicle features. In Example 150, the system of Examples 145, 217, 227, and 237, wherein the processing circuitry is configured to receive from the base station, a capability information to indicate one or more other base stations that include specialized features to support communications with the AV-UE. In Example 151, the system of Examples 145, 217, 227, and 237, wherein the processing circuitry is configured to receive from the base station, a signal to enable or disable communications between the base station and the AV-UE via a radio resource control (RRC) layer message. In Example 152, the system of Examples 145, 217, 227, and 237, wherein the processing circuitry is configured to receive from the base station, a signal to enable or disable communications between the base station and the AV-UE via a radio resource control (RRC) layer message or a system information block, wherein the system information block is transmitted to the AV-UE, to a group of AV-UEs, or to all AV-UEs. In Example 153, the system of Examples 145, 217, 227, and 237, wherein the measurement configuration comprises a measurement configuration specific for aerial vehicle application comprising both periodic and event trigger measurement events. In Example 154, the system of Examples 145, 217, 227, and 237, wherein the measurement configuration comprises a measurement configuration specific for aerial vehicle application to trigger an aerial vehicle function other than generation of a measurement report. In Example 155, the system of Example 154, wherein the measurement configuration comprises one or more criteria for the aerial vehicle function. In Example 156, the system of Example 154, wherein the aerial vehicle function comprises an interference avoidance function. In Example 157, the system of Example 156, wherein an interference avoidance function comprises an interference nulling function. In Example 158, the system of Example 156, wherein an interference avoidance function comprises an interference mitigation function. In Example 159, the system of Examples 145, 217, 227, and 237, wherein the AV-UE comprises a user equipment with a subscriber identity module (SIM) to enable an aerial vehicle features, wherein the SIM is a physical SIM or a Soft SIM. In Example 160, the system of Examples 145, 217, 227, and 237, wherein the measurement configuration comprises a measurement of height, velocity, and interference from one or more cells and a measurement of a number of detected cells, the measurement configuration to include a threshold for the number of detected cells as a second trigger event, to instruct the AV-UE to transmit, in response to detection of the second trigger event, a measurement report to the base station. In Example 161, the system of Examples 145, 217, 227, and 237, wherein the measurement configuration comprises configuration of an uplink measurement for the AV-UE. In Example 162, the system of Examples 145, 217, 227, and 237, wherein the processing circuitry is configured to transmit, via the physical layer device, a map of a high-density area for communications to the AV-UE to enable an aerial vehicle function. In Example 163, the system of Example 162, wherein transmission of the map of the high-density area for communications to the AV-UE to enable an aerial vehicle function comprises a map based trigger event to instruct the AV-UE to reduce power for transmissions from the AV-UE in response to entering an indicator area identified by the map. In Example 164, the system of Examples 145, 217, 227, and 237, wherein the processing circuitry is configured to communicate with the AV-UE, to indicate to the AV-UE to reduce transmission power. In Example 165, the system of Examples 145, 217, 227, and 237, wherein the processing circuitry is configured to communicate with the AV-UE, to enable a specialized aerial vehicle feature, the specialized aerial vehicle feature to comprise interference nulling. In Example 166, the system of Examples 145, 217, 227, and 237, wherein the processing circuitry is configured to performing at least one measurement of a configured measurement type of detected cells on all the layers of carrier frequencies, wherein the configured measurement types comprise at least Reference Signal Received Power (RSRP), Reference Signal Received Quality (RSRQ), Reference Signal-Signal to Noise and Interference Ratio (RS-SINR), New Radio Synchronization Signal-Reference Signal Received Power (NR SS-RSRP), New Radio Synchronization Signal-Reference Signal Received Quality (NR SS-RSRQ), and New Radio Synchronization Signal-Signal to Noise and Interference Ratio (NR SS-SINR).

Example 167, a machine-readable medium containing instructions, which when executed by a processor, cause the processor to perform operations, the operations comprising: encoding, by baseband processing circuitry, capabilities information for a user device, to transmit to a base station, the capabilities information to indicate that the user device is part of an aerial vehicle (AV-UE); and decoding, by the baseband processing circuitry, a measurement configuration from a physical layer, the measurement configuration to establish a trigger event based on a height measurement, the measurement configuration to instruct the AV-UE to transmit, in response to detection of the trigger event, a measurement report to the base station comprising interference information for downlink communications between the base station and the AV-UE. In Example 168, the machine-readable medium of Examples 167, 214, 224, and 234, wherein the operations further comprise receiving, by the baseband processing circuitry, from the base station, capability information to indicate that the base station includes specialized aerial vehicle features to support communications with the AV-UE. In Example 169, the machine-readable medium of Examples 167, 214, 224, and 234, wherein the operations further comprise receiving, by the baseband processing circuitry, from the base station, capability information to indicate that one or more of the specialized aerial vehicle features are enabled. In Example 170, the machine-readable medium of Examples 167, 214, 224, and 234, wherein the operations further comprise receiving, by the baseband processing circuitry, from the base station, capability information to indicate parameters for one or more specialized aerial vehicle features that are valid and that the AV-UE will use if the base station enables the one or more specialized aerial vehicle features. In Example 171, the machine-readable medium of Examples 167, 214, 224, and 234, wherein the operations further comprise receiving, by the baseband processing circuitry, from the base station, a capability information to indicate one or more other base stations that include specialized features to support communications with the AV-UE. In Example 172, the machine-readable medium of Examples 167, 214, 224, and 234, wherein the operations further comprise receiving, by the baseband processing circuitry, from the base station, a signal to enable or disable communications between the base station and the AV-UE via a radio resource control (RRC) layer message. In Example 173, the machine-readable medium of Examples 167, 214, 224, and 234, wherein the operations further comprise receiving, by the baseband processing circuitry, from the base station, a signal to enable or disable communications between the base station and the AV-UE via a radio resource control (RRC) layer message or a system information block, wherein the system information block is transmitted to the AV-UE, to a group of AV-UEs, or to all AV-UEs. In Example 174, the machine-readable medium of Examples 167, 214, 224, and 234, wherein the measurement configuration comprises a measurement configuration specific for aerial vehicle application comprising both periodic and event trigger measurement events. In Example 175, the machine-readable medium of Examples 167, 214, 224, and 234, wherein the measurement configuration comprises a measurement configuration specific for aerial vehicle application to trigger an aerial vehicle function other than generation of a measurement report. In Example 176, the machine-readable medium of Example 175, wherein the measurement configuration comprises one or more criteria for the aerial vehicle function. In Example 177, the machine-readable medium of Example 175, wherein the aerial vehicle function comprises an interference avoidance function. In Example 178, the machine-readable medium of Example 177, wherein an interference avoidance function comprises an interference nulling function. In Example 179, the machine-readable medium of Example 177, wherein an interference avoidance function comprises an interference mitigation function. In Example 180, the machine-readable medium of Examples 167, 214, 224, and 234, wherein the AV-UE comprises a user equipment with a subscriber identity module (SIM) to enable an aerial vehicle features, wherein the SIM is a physical SIM or a Soft SIM. In Example 181, the machine-readable medium of Examples 167, 214, 224, and 234, wherein the measurement configuration comprises a measurement of height, velocity, and interference from one or more cells and a measurement of a number of detected cells, the measurement configuration to include a threshold for the number of detected cells as a second trigger event, to instruct the AV-UE to transmit, in response to detection of the second trigger event, a measurement report to the base station. In Example 182, the machine-readable medium of Examples 167, 214, 224, and 234, wherein the measurement configuration comprises configuration of an uplink measurement for the AV-UE. In Example 183, the machine-readable medium of Examples 167, 214, 224, and 234, wherein the operations further comprise transmitting, by the base station via the physical layer device, a map of a high-density area for communications to the AV-UE to enable an aerial vehicle function. In Example 184, the machine-readable medium of Example 183, wherein transmitting, by the base station, the map of the high-density area for communications to the AV-UE to enable an aerial vehicle function comprises a map based trigger event to instruct the AV-UE to reduce power for transmissions from the AV-UE in response to entering an indicator area identified by the map. In Example 185, the machine-readable medium of Examples 167, 214, 224, and 234, wherein the operations further comprise communicating, by the baseband processing circuitry, with the AV-UE, to indicate to the AV-UE to reduce transmission power. In Example 186, the machine-readable medium of Examples 167, 214, 224, and 234, wherein the operations further comprise communicating, by the baseband processing circuitry, with the AV-UE, to enable a specialized aerial vehicle feature, the specialized aerial vehicle feature to comprise interference nulling. In Example 187, the machine-readable medium of Examples 167, 214, 224, and 234, wherein the user device is capable of performing at least one measurement of a configured measurement type of detected cells on all the layers of carrier frequencies, wherein the configured measurement types comprise at least Reference Signal Received Power (RSRP), Reference Signal Received Quality (RSRQ), Reference Signal-Signal to Noise and Interference Ratio (RS-SINR), New Radio Synchronization Signal-Reference Signal Received Power (NR SS-RSRP), New Radio Synchronization Signal-Reference Signal Received Quality (NR SS-RSRQ), and New Radio Synchronization Signal-Signal to Noise and Interference Ratio (NR SS-SINR). In Example 188 is a device to signal for aerial vehicles, comprising: a means for encoding capabilities information for a user device, the capabilities information to indicate that the user device is part of an aerial vehicle (AV-UE); and a means for decoding a measurement configuration, the measurement configuration to establish a trigger event based on a height measurement, the measurement configuration to instruct the AV-UE to transmit, in response to detection of the trigger event, a measurement report to a base station comprising interference information for downlink communications between the base station and the AV-UE. In Example 189, the device of Examples 188, 218, 228, and 238, further comprising a means for receiving from the base station, capability information to indicate that the base station includes specialized aerial vehicle features to support communications with the AV-UE. In Example 190, the device of Examples 188, 218, 228, and 238, further comprising a means for receiving from the base station, capability information to indicate that one or more of the specialized aerial vehicle features are enabled. In Example 191, the device of Examples 188, 218, 228, and 238, further comprising a means for receiving from the base station, capability information to indicate parameters for one or more specialized aerial vehicle features that are valid and that the AV-UE will use if the base station enables the one or more specialized aerial vehicle features. In Example 192, the device of Examples 188, 218, 228, and 238, further comprising a means for receiving from the base station, a capability information to indicate one or more other base stations that include specialized features to support communications with the AV-UE. In Example 193, the device of Examples 188, 218, 228, and 238, further comprising a means for receiving from the base station, a signal to enable or disable communications between the base station and the AV-UE via a radio resource control (RRC) layer message. In Example 194, the device of Examples 188, 218, 228, and 238, further comprising a means for receiving from the base station, a signal to enable or disable communications between the base station and the AV-UE via a radio resource control (RRC) layer message or a system information block, wherein the system information block is transmitted to the AV-UE, to a group of AV-UEs, or to all AV-UEs. In Example 195, the device of Examples 188, 218, 228, and 238, wherein the measurement configuration comprises a measurement configuration specific for aerial vehicle application comprising both periodic and event trigger measurement events. In Example 196, the device of Examples 188, 218, 228, and 238, wherein the measurement configuration comprises a measurement configuration specific for aerial vehicle application to trigger an aerial vehicle function other than generation of a measurement report. In Example 197, the device of Example 196, wherein the measurement configuration comprises one or more criteria for the aerial vehicle function. In Example 198, the device of Example 196, wherein the aerial vehicle function comprises an interference avoidance function. In Example 199, the device of Example 198, wherein an interference avoidance function comprises an interference nulling function. In Example 200, the device of Example 198, wherein an interference avoidance function comprises an interference mitigation function. In Example 201, the device of Examples 188, 218, 228, and 238, wherein the AV-UE comprises a user equipment with a subscriber identity module (SIM) to enable an aerial vehicle features, wherein the SIM is a physical SIM or a Soft SIM. In Example 202, the device of Examples 188, 218, 228, and 238, wherein the measurement configuration comprises a measurement of height, velocity, and interference from one or more cells and a measurement of a number of detected cells, the measurement configuration to include a threshold for the number of detected cells as a second trigger event, to instruct the AV-UE to transmit, in response to detection of the second trigger event, a measurement report to the base station. In Example 203, the device of Examples 188, 218, 228, and 238, wherein the measurement configuration comprises configuration of an uplink measurement for the AV-UE. In Example 204, the device of Examples 188, 218, 228, and 238, further comprising a means for transmitting a map of a high-density area for communications to the AV-UE to enable an aerial vehicle function. In Example 205, the device of Example 204, wherein transmitting, by the base station, the map of the high-density area for communications to the AV-UE to enable an aerial vehicle function comprises a map based trigger event to instruct the AV-UE to reduce power for transmissions from the AV-UE in response to entering an indicator area identified by the map. In Example 206, the device of Examples 188, 218, 228, and 238, further comprising a means for communicating with the AV-UE, to indicate to the AV-UE to reduce transmission power. In Example 207, the device of Examples 188, 218, 228, and 238, further comprising a means for communicating with the AV-UE, to enable a specialized aerial vehicle feature, the specialized aerial vehicle feature to comprise interference nulling. In Example 208, the device of Examples 188, 218, 228, and 238, wherein the user device is capable of performing at least one measurement of a configured measurement type of detected cells on all the layers of carrier frequencies, wherein the configured measurement types comprise at least Reference Signal Received Power (RSRP), Reference Signal Received Quality (RSRQ), Reference Signal-Signal to Noise and Interference Ratio (RS-SINR), New Radio Synchronization Signal-Reference Signal Received Power (NR SS-RSRP), New Radio Synchronization Signal-Reference Signal Received Quality (NR SS-RSRQ), and New Radio Synchronization Signal-Signal to Noise and Interference Ratio (NR SS-SINR).

Example 209 is an apparatus to signal for aerial vehicles, comprising: processing circuitry to decode uplink data including capabilities information, the capabilities information to indicate that the user device is part of an aerial vehicle (AV-UE); and to generate a data unit comprising a measurement configuration, the measurement configuration to establish a trigger event, the measurement configuration to instruct the AV-UE to transmit a measurement report, only in response to detection of the trigger event, to the base station comprising interference information for downlink communications between the base station and the AV-UE; and an interface coupled with the processing circuitry to send the data unit to a physical layer.

Example 210 is a method to signal for aerial vehicles, comprising: receiving, by the baseband processing circuitry, capabilities information from a user device, the capabilities information to indicate that the user device is part of an aerial vehicle (AV-UE); and generating, by the baseband processing circuitry, to send to a physical layer, a measurement configuration, the measurement configuration to establish a trigger event, the measurement configuration to instruct the AV-UE to transmit a measurement report, only in response to detection of the trigger event, to the base station comprising interference information for downlink communications between the base station and the AV-UE.

Example 211, a machine-readable medium containing instructions, which when executed by a processor, cause the processor to perform operations, the operations comprising: receiving, by the baseband processing circuitry, capabilities information from a user device, the capabilities information to indicate that the user device is part of an aerial vehicle (AV-UE); and generating, by the baseband processing circuitry, to send to a physical layer, a measurement configuration, the measurement configuration to establish a trigger event, the measurement configuration to instruct the AV-UE to transmit a measurement report, only in response to detection of the trigger event, to the base station comprising interference information for downlink communications between the base station and the AV-UE.

Example 212 is an apparatus to signal for aerial vehicles, comprising: a physical layer device to encode capabilities information for a user device, the capabilities information to indicate that the user device is part of an aerial vehicle (AV-UE); and processing circuitry coupled with the physical layer to decode a measurement configuration, the measurement configuration to establish a trigger event, the measurement configuration to instruct the AV-UE to transmit a measurement report, only in response to detection of the trigger event, to the base station comprising interference information for downlink communications between the base station and the AV-UE.

Example 213 is a method to signal for aerial vehicles, comprising: encoding, by baseband processing circuitry, capabilities information for a user device, to transmit to a base station, the capabilities information to indicate that the user device is part of an aerial vehicle (AV-UE); and decoding, by the baseband processing circuitry, a measurement configuration from a physical layer, the measurement configuration to establish a trigger event, the measurement configuration to instruct the AV-UE to transmit a measurement report, only in response to detection of the trigger event, to the base station comprising interference information for downlink communications between the base station and the AV-UE.

Example 214, a machine-readable medium containing instructions, which when executed by a processor, cause the processor to perform operations, the operations comprising: encoding, by baseband processing circuitry, capabilities information for a user device, to transmit to a base station, the capabilities information to indicate that the user device is part of an aerial vehicle (AV-UE); and decoding, by the baseband processing circuitry, a measurement configuration from a physical layer, the measurement configuration to establish a trigger event, the measurement configuration to instruct the AV-UE to transmit a measurement report, only in response to detection of the trigger event, to the base station comprising interference information for downlink communications between the base station and the AV-UE.

Example 215, a system to signal for aerial vehicles, comprising: one or more antennas; processing circuitry to decode uplink data including capabilities information, the capabilities information to indicate that the user device is part of an aerial vehicle (AV-UE); and to generate a data unit comprising a measurement configuration, the measurement configuration to establish a trigger event, the measurement configuration to instruct the AV-UE to transmit a measurement report, only in response to detection of the trigger event, to the base station comprising interference information for downlink communications between the base station and the AV-UE; and a physical layer device coupled with the processing circuitry and the one or more antennas to transmit the frame with a preamble.

### Example 216

A device to signal for aerial vehicles, comprising: a means for receiving capabilities information from a user device, the capabilities information to indicate that the user device is part of an aerial vehicle (AV-UE); and a means for generating, by the baseband processing circuitry, to send to a physical layer, a measurement configuration, the measurement configuration to establish a trigger event, the measurement configuration to instruct the AV-UE to transmit a measurement report, only in response to detection of the trigger event, to the base station comprising interference information for downlink communications between the base station and the AV-UE.

Example 217, a system to signal for aerial vehicles, comprising: one or more antennas;

a physical layer device coupled with the one or more antennas to transmit capabilities information from a user device, the capabilities information to indicate that the user device is part of an aerial vehicle (AV-UE); and processing circuitry coupled with the physical layer to decode a measurement configuration, the measurement configuration to establish a trigger event, the measurement configuration to instruct the AV-UE to transmit a measurement report, only in response to detection of the trigger event, to the base station comprising interference information for downlink communications between the base station and the AV-UE.

Example 218 is a device to signal for aerial vehicles, comprising: a means for encoding capabilities information for a user device, the capabilities information to indicate that the user device is part of an aerial vehicle (AV-UE); and a means for decoding a measurement configuration, the measurement configuration to establish a trigger event, the measurement configuration to instruct the AV-UE to transmit a measurement report, only in response to detection of the trigger event, to the base station comprising interference information for downlink communications between the base station and the AV-UE.

Example 219 is an apparatus to signal for aerial vehicles, comprising: processing circuitry to decode uplink data including capabilities information, the capabilities information to indicate that the user device is part of an aerial vehicle (AV-UE); and to generate a data unit comprising a measurement configuration, the measurement configuration to establish a trigger event, the measurement configuration to instruct the AV-UE to transmit, in response to detection of the trigger event, a measurement report to a base station comprising location information to identify a location of the AV-UE and interference information for downlink communications between the base station and the AV-UE; and an interface coupled with the processing circuitry to send the data unit to a physical layer.

Example 220 is a method to signal for aerial vehicles, comprising: receiving, by the baseband processing circuitry, capabilities information from a user device, the capabilities information to indicate that the user device is part of an aerial vehicle (AV-UE); and generating, by the baseband processing circuitry, to send to a physical layer, a measurement configuration, the measurement configuration to establish a trigger event, the measurement configuration to instruct the AV-UE to transmit, in response to detection of the trigger event, a measurement report to a base station comprising location information to identify a location of the AV-UE and interference information for downlink communications between the base station and the AV-UE.

Example 221, a machine-readable medium containing instructions, which when executed by a processor, cause the processor to perform operations, the operations comprising: receiving, by the baseband processing circuitry, capabilities information from a user device, the capabilities information to indicate that the user device is part of an aerial vehicle (AV-UE); and generating, by the baseband processing circuitry, to send to a physical layer, a measurement configuration, the measurement configuration to establish a trigger event, the measurement configuration to instruct the AV-UE to transmit, in response to detection of the trigger event, a measurement report to a base station comprising location information to identify a location of the AV-UE and interference information for downlink communications between the base station and the AV-UE.

Example 222 is an apparatus to signal for aerial vehicles, comprising: a physical layer device to encode capabilities information for a user device, the capabilities information to indicate that the user device is part of an aerial vehicle (AV-UE); and processing circuitry coupled with the physical layer to decode a measurement configuration, the measurement configuration to establish a trigger event, the measurement configuration to instruct the AV-UE to transmit, in response to detection of the trigger event, a measurement report to a base station comprising location information to identify a location of the AV-UE and interference information for downlink communications between the base station and the AV-UE.

Example 223 is a method to signal for aerial vehicles, comprising: encoding, by baseband processing circuitry, capabilities information for a user device, to transmit to a base station, the capabilities information to indicate that the user device is part of an aerial vehicle (AV-UE); and decoding, by the baseband processing circuitry, a measurement configuration from a physical layer, the measurement configuration to establish a trigger event, the measurement configuration to instruct the AV-UE to transmit, in response to detection of the trigger event, a measurement report to a base station comprising location information to identify a location of the AV-UE and interference information for downlink communications between the base station and the AV-UE.

Example 224, a machine-readable medium containing instructions, which when executed by a processor, cause the processor to perform operations, the operations comprising: encoding, by baseband processing circuitry, capabilities information for a user device, to transmit to a base station, the capabilities information to indicate that the user device is part of an aerial vehicle (AV-UE); and decoding, by the baseband processing circuitry, a measurement configuration from a physical layer, the measurement configuration to establish a trigger event, the measurement configuration to instruct the AV-UE to transmit, in response to detection of the trigger event, a measurement report to the base station comprising location information to identify a location of the AV-UE and interference information for downlink communications between the base station and the AV-UE.

Example 225, a system to signal for aerial vehicles, comprising: one or more antennas;

processing circuitry to decode uplink data including capabilities information, the capabilities information to indicate that the user device is part of an aerial vehicle (AV-UE); and to generate a data unit comprising a measurement configuration, the measurement configuration to establish a trigger event, the measurement configuration to instruct the AV-UE to transmit, in response to detection of the trigger event, a measurement report to a base station comprising location information to identify a location of the AV-UE and interference information for downlink communications between the base station and the AV-UE; and a physical layer device coupled with the processing circuitry and the one or more antennas to transmit the frame with a preamble.

### Example 226

A device to signal for aerial vehicles, comprising: a means for receiving capabilities information from a user device, the capabilities information to indicate that the user device is part of an aerial vehicle (AV-UE); and a means for generating, by the baseband processing circuitry, to send to a physical layer, a measurement configuration, the measurement configuration to establish a trigger event, the measurement configuration to instruct the AV-UE to transmit, in response to detection of the trigger event, a measurement report to a base station comprising location information to identify a location of the AV-UE and interference information for downlink communications between the base station and the AV-UE.

Example 227, a system to signal for aerial vehicles, comprising: one or more antennas;

a physical layer device coupled with the one or more antennas to transmit capabilities information from a user device, the capabilities information to indicate that the user device is part of an aerial vehicle (AV-UE); and processing circuitry coupled with the physical layer to decode a measurement configuration, the measurement configuration to establish a trigger event, the measurement configuration to instruct the AV-UE to transmit, in response to detection of the trigger event, a measurement report to a base station comprising location information to identify a location of the AV-UE and interference information for downlink communications between the base station and the AV-UE.

Example 228 is a device to signal for aerial vehicles, comprising: a means for encoding capabilities information for a user device, the capabilities information to indicate that the user device is part of an aerial vehicle (AV-UE); and a means for decoding a measurement configuration, the measurement configuration to establish a trigger event, the measurement configuration to instruct the AV-UE to transmit, in response to detection of the trigger event, a measurement report to a base station comprising location information to identify a location of the AV-UE and interference information for downlink communications between the base station and the AV-UE.

Example 229 is an apparatus to signal for aerial vehicles, comprising: processing circuitry to decode uplink data including capabilities information, the capabilities information to indicate that the user device is part of an aerial vehicle (AV-UE); and to generate a data unit comprising a measurement configuration, the measurement configuration to establish one or more scaling factors for time-to-trigger and Layer-3 (L3) filtering, the measurement configuration to instruct the AV-UE to transmit a measurement report based on the one or more scaling factors to the base station, the measurement report comprising interference information for downlink communications between the base station and the AV-UE; and an interface coupled with the processing circuitry to send the data unit to a physical layer.

Example 230 is a method to signal for aerial vehicles, comprising: receiving, by the baseband processing circuitry, capabilities information from a user device, the capabilities information to indicate that the user device is part of an aerial vehicle (AV-UE); and generating, by the baseband processing circuitry, to send to a physical layer, a measurement configuration, the measurement configuration to establish one or more scaling factors for time-to-trigger and Layer-3 (L3) filtering, the measurement configuration to instruct the AV-UE to transmit a measurement report based on the one or more scaling factors to the base station, the measurement report comprising interference information for downlink communications between the base station and the AV-UE.

Example 231, a machine-readable medium containing instructions, which when executed by a processor, cause the processor to perform operations, the operations comprising: receiving, by the baseband processing circuitry, capabilities information from a user device, the capabilities information to indicate that the user device is part of an aerial vehicle (AV-UE); and generating, by the baseband processing circuitry, to send to a physical layer, a measurement configuration, the measurement configuration to establish one or more scaling factors for time-to-trigger and Layer-3 (L3) filtering, the measurement configuration to instruct the AV-UE to transmit a measurement report based on the one or more scaling factors to the base station, the measurement report comprising interference information for downlink communications between the base station and the AV-UE.

Example 232 is an apparatus to signal for aerial vehicles, comprising: a physical layer device to encode capabilities information for a user device, the capabilities information to indicate that the user device is part of an aerial vehicle (AV-UE); and processing circuitry coupled with the physical layer to decode a measurement configuration, the measurement configuration to establish one or more scaling factors for time-to-trigger and Layer-3 (L3) filtering, the measurement configuration to instruct the AV-UE to transmit a measurement report based on the one or more scaling factors to the base station, the measurement report comprising interference information for downlink communications between the base station and the AV-UE.

Example 233 is a method to signal for aerial vehicles, comprising: encoding, by baseband processing circuitry, capabilities information for a user device, to transmit to a base station, the capabilities information to indicate that the user device is part of an aerial vehicle (AV-UE); and decoding, by the baseband processing circuitry, a measurement configuration from a physical layer, the measurement configuration to establish one or more scaling factors for time-to-trigger and Layer-3 (L3) filtering, the measurement configuration to instruct the AV-UE to transmit a measurement report based on the one or more scaling factors to the base station, the measurement report comprising interference information for downlink communications between the base station and the AV-UE.

Example 234, a machine-readable medium containing instructions, which when executed by a processor, cause the processor to perform operations, the operations comprising: encoding, by baseband processing circuitry, capabilities information for a user device, to transmit to a base station, the capabilities information to indicate that the user device is part of an aerial vehicle (AV-UE); and decoding, by the baseband processing circuitry, a measurement configuration from a physical layer, the measurement configuration to establish one or more scaling factors for time-to-trigger and Layer-3 (L3) filtering, the measurement configuration to instruct the AV-UE to transmit a measurement report based on the one or more scaling factors to the base station, the measurement report comprising interference information for downlink communications between the base station and the AV-UE.

Example 235, a system to signal for aerial vehicles, comprising: one or more antennas; processing circuitry to decode uplink data including capabilities information, the capabilities information to indicate that the user device is part of an aerial vehicle (AV-UE); and to generate a data unit comprising a measurement configuration, the measurement configuration to establish one or more scaling factors for time-to-trigger and Layer-3 (L3) filtering, the measurement configuration to instruct the AV-UE to transmit a measurement report based on the one or more scaling factors to the base station, the measurement report comprising interference information for downlink communications between the base station and the AV-UE; and a physical layer device coupled with the processing circuitry and the one or more antennas to transmit the frame with a preamble.

### Example 236

A device to signal for aerial vehicles, comprising: a means for receiving capabilities information from a user device, the capabilities information to indicate that the user device is part of an aerial vehicle (AV-UE); and a means for generating, by the baseband processing circuitry, to send to a physical layer, a measurement configuration, the measurement configuration to establish one or more scaling factors for time-to-trigger and Layer-3 (L3) filtering, the measurement configuration to instruct the AV-UE to transmit a measurement report based on the one or more scaling factors to the base station, the measurement report comprising interference information for downlink communications between the base station and the AV-UE.

Example 237, a system to signal for aerial vehicles, comprising: one or more antennas; a physical layer device coupled with the one or more antennas to transmit capabilities information from a user device, the capabilities information to indicate that the user device is part of an aerial vehicle (AV-UE); and processing circuitry coupled with the physical layer to decode a measurement configuration, the measurement configuration to establish one or more scaling factors for time-to-trigger and Layer-3 (L3) filtering, the measurement configuration to instruct the AV-UE to transmit a measurement report based on the one or more scaling factors to the base station, the measurement report comprising interference information for downlink communications between the base station and the AV-UE.

Example 238 is a device to signal for aerial vehicles, comprising: a means for encoding capabilities information for a user device, the capabilities information to indicate that the user device is part of an aerial vehicle (AV-UE); and a means for decoding a measurement configuration, the measurement configuration to establish one or more scaling factors for time-to-trigger and Layer-3 (L3) filtering, the measurement configuration to instruct the AV-UE to transmit a measurement report based on the one or more scaling factors to the base station, the measurement report comprising interference information for downlink communications between the base station and the AV-UE.

1.-29. (canceled)

30. A non-transitory machine-readable medium containing instructions, which when executed by a processor, cause the processor to perform operations, the operations comprising:
generating, by baseband processing circuitry, a measurement configuration, the measurement configuration to transmit to an aerial vehicle user equipment (AV-UE), the measurement configuration to:
establish a trigger event based on a height measurement compared against a height threshold; and
cause the AV-UE to transmit, in response to detection of the trigger event, a measurement report to a base station comprising interference information for downlink communications between the base station and the AV-UE.

31. The non-transitory machine-readable medium of claim 30, the measurement configuration to further establish a second trigger event based on a measurement of signals from one or more nodes for N cells in which the number of cells, N, exceeds a threshold number of cells.

32. The non-transitory machine-readable medium of claim 30, wherein the measurement configuration comprises a measurement configuration specific for aerial vehicle application to trigger an aerial vehicle function other than generation of the measurement report.

33. The non-transitory machine-readable medium of claim 32, further comprising instructions, which when executed by the processor, cause the processor to perform operations, the operations comprising decoding, by the baseband processing circuitry, uplink data including capabilities information of the AV-UE.

34. The non-transitory machine-readable medium of claim 32, wherein the aerial vehicle function comprises an interference avoidance function.

35. The non-transitory machine-readable medium of claim 33, wherein the interference avoidance function comprises either an interference nulling function or an interference mitigation function.

36. A non-transitory machine-readable medium containing instructions, which when executed by a processor, cause the processor to perform operations, the operations comprising:
decoding, by baseband processing circuitry, a measurement configuration, the measurement configuration to:
establish a trigger event based on a height measurement compared against a height threshold; and
transmit, in response to detection of the trigger event, a measurement report comprising interference measurements to a base station.

37. The non-transitory machine-readable medium of claim 36, the measurement configuration to further establish a second trigger event based on a measurement of signals from one or more nodes for N cells in which the number of cells, N, exceeds a threshold number of cells.

38. The non-transitory machine-readable medium of claim 36, wherein the operations further comprise encoding, by the baseband processing circuitry, capabilities information to be transmitted to the base station, the capabilities information to indicate aerial vehicle user equipment (AV-UE) capability, wherein the capabilities information further indicates one or more other base stations that include specialized features to support communications with the AV-UE.

39. The non-transitory machine-readable medium of claim 36, wherein the operations further comprise receiving, by the baseband processing circuitry, from the base station, a signal to enable or disable communications between the base station and the AV-UE via a radio resource control (RRC) layer message or a system information block, wherein the system information block is transmitted to the AV-UE, to a group of AV-UEs, or to all AV-UEs.

40. The non-transitory machine-readable medium of claim 36, wherein the measurement configuration comprises a measurement configuration specific for aerial vehicle application to trigger an aerial vehicle function other than generation of the measurement report.

41. The non-transitory machine-readable medium of claim 40, wherein the aerial vehicle function comprises an interference avoidance function.

42. The non-transitory machine-readable medium of claim 40, wherein the interference avoidance function comprises either an interference nulling function or an interference mitigation function.

43. An apparatus to signal for aerial vehicles, comprising:
an interface; and
processing circuitry to issue, via the interface, a measurement configuration to transmit to an aerial vehicle user equipment (AV-UE), the measurement configuration:
to establish a trigger event based on a height measurement that the AV-UE compares against a height threshold; and
to cause the AV-UE to transmit, in response to detection of the trigger event, a measurement report comprising interference measurements obtained by the AV-UE.

44. The apparatus of claim 43, the measurement configuration to further establish a second trigger event based on a measurement of signals from one or more nodes for N cells in which the number of cells, N, exceeds a threshold number of cells.

45. The apparatus of claim 43, wherein the processing circuitry is configured to decode uplink data including capabilities information of the AV-UE.

46. The apparatus of claim 43, further comprising a memory coupled with the processing circuitry, a radio coupled with the interface, and one or more antennas coupled with the radio to communicate with the AV-UE.

47. The apparatus of claim 43, wherein the processing circuitry is configured to communicate with the AV-UE, capability information to indicate that the processing circuitry includes specialized aerial vehicle features to support communications with the AV-UE.

48. The apparatus of claim 43, wherein the processing circuitry is configured to communicate with the AV-UE, capability information to indicate that one or more of the specialized aerial vehicle features are enabled.

49. The apparatus of claim 43, wherein the processing circuitry is configured to communicate with the AV-UE, capability information to indicate parameters for one or more specialized aerial vehicle features that are valid and that the AV-UE will use if the one or more specialized aerial vehicle features are enabled.

50. The apparatus of claim 43, wherein the processing circuitry is configured to communicate with the AV-UE, a signal to enable or disable communications with the AV-UE via a radio resource control (RRC) layer message or a system information block, wherein the system information block is transmitted to the AV-UE, to a group of AV-UEs, or to all AV-UEs.
apparatus (UE)

51. An apparatus to signal for aerial vehicles, comprising:
an interface; and
processing circuitry coupled with the interface, the processing circuitry to decode a measurement configuration, the measurement configuration to:
establish a trigger event based on a height measurement compared against a height threshold; and
cause to transmit, in response to detection of the trigger event, a measurement report to a base station comprising interference information for downlink communications with the base station.

52. The apparatus of claim 51, the measurement configuration to further establish a second trigger event based on a measurement of signals from one or more nodes for N cells in which the number of cells, N, exceeds a threshold number of cells.

53. The apparatus of claim 51, wherein the interface is further configured to encode capabilities information, the capabilities information to indicate aerial vehicle user equipment (AV-UE) capability.

54. The apparatus of claim 51, further comprising a memory coupled with the processing circuitry, a radio coupled with the interface, and one or more antennas coupled with the radio to communicate with the base station.
